(19) United States
(12) Patent Application Publication
(10) Pub. No.: US 2025/0139962 A1
(43) Pub. Date: May 1, 2025

(54) METHOD OF DETERMINING STATE OF WALKING TERRAIN AND ELECTRONIC DEVICE FOR PERFORMING THE METHOD

(71) Applicant: Samsung Electronics Co., Ltd., Suwon-si (KR)

(72) Inventors: Kihun LEE, Suwon-si (KR); Hongchul CHO, Suwon-si (KR)

(21) Appl. No.: 18/919,083

(22) Filed: Oct. 17, 2024

Related U.S. Application Data
(63) Continuation of application No. PCT/KR2024/011414, filed on Aug. 2, 2024.

(30) Foreign Application Priority Data
Oct. 27, 2023 (KR) 10-2023-0146091
Dec. 12, 2023 (KR) 10-2023-0180155

(51) Int. Cl. G06V 20/10; A61H 1/02; A61H 3/00; G01B 7/30; G01C 21/16; G01D 5/14; G06T 7/50; G06V 10/25; G06V 10/74; G06V 40/10

(52) U.S. Cl. CPC G06V 20/10; A61H 1/0244; A61H 3/00; G01B 7/30; G01C 21/16; G01D 5/145; G06T 7/50; G06V 10/25; G06V 10/761; G06V 40/10; A61H 2003/007; A61H 2201/163; A61H 2201/1642; A61H 2201/5007; A61H 2201/5064; A61H 2201/5069; A61H 2201/5084; G06T 2207/10028

(57) ABSTRACT

A method of determining a state of a walking terrain is provided for a wearable walking assist and/or exercise device. The method may include generating a first image by capturing a scene using a distance sensor, identifying at least one of a left leg or a right leg of a user in the first image based on depth information of the first image, setting a first region of interest (RoI) in the first image based on at least one of the left leg or the right leg, generating a first depth value pattern for the first RoI based on depth information of the first RoI, and determining a first state of a walking terrain corresponding to the first RoI based on the first depth value pattern.

### CROSS-REFERENCE TO RELATED APPLICATIONS

This application is a national stage application of International Application No. PCT/KR2024/011414 designating the United States, filed on Aug. 2, 2024, in the Korean Intellectual Property Receiving Office and claiming priority to Korean Patent Application No. 10-2023-0146091, filed on Oct. 27, 2023, and Korean Patent Application No. 10-2023-0180155, filed on Dec. 12, 2023, in the Korean Intellectual Property Office, the disclosures of which are all hereby incorporated by reference herein in their entireties.

### BACKGROUND

### 1. Field

Certain example embodiments relate to technology for determining a state of a terrain on which a user walks or is to walk.

### 2. Description of Related Art

A change into aging societies has contributed to a growing number of people who experience inconvenience and pain from reduced muscular strength or joint problems due to aging. Thus, there is a growing interest in walking assist devices that enable elderly users or patients with reduced muscular strength or joint problems to walk with less effort, and/or which allow people to exercise.

### SUMMARY

According to an example embodiment, a wearable device configured to be worn on the body of a user, a base body thereof configured to be positioned at a waist area of the user, a waist support frame and second and first leg support frames configured to support at least part of the body of the user, second and first thigh fastening portions configured to fix the second and first leg support frames to a thigh of the user, an inertial measurement unit (IMU) disposed within the base body, driving modules, comprising a motor and/or circuitry, configured to generate a torque to be applied to a leg of the user, in which the driving modules are positioned between the waist support frame and the second and first leg support frames, an angle sensor configured to measure a rotation angle of the second and first leg support frames, a distance sensor configured to calculate a distance to a surrounding scene of the wearable device, and control modules, each including at least one processor comprising processing circuitry, configured to control the wearable device and a memory configured to store instructions executable individually and/or collectively by the at least one processor, in which, when executed by the at least one processor, the instructions are configured to cause the wearable device to at least generate a first image by capturing a scene using the distance sensor, identify at least one of the left leg or the right leg of the user in the first image based on depth information of the first image, set a first region of interest (RoI) in the first image based on at least one of the left leg or the right leg, generate a first depth value pattern for the first RoI based on depth information of the first RoI, and determine a first state of a walking terrain corresponding to the first RoI based on the first depth value pattern.

According to an example embodiment, a method of determining a state of a walking terrain may include generating a first image by capturing a scene using a distance sensor, identifying at least one of a left leg or a right leg of a user in the first image based on depth information of the first image, setting a first RoI in the first image based on at least one of the left leg or the right leg, generating a first depth value pattern for the first RoI based on depth information of the first RoI, and determining a first state of a walking terrain corresponding to the first RoI based on the first depth value pattern.

According to an example embodiment, a wearable device may include, when the wearable device is worn on the body of a user, a base body positioned at a waist area of the user, a waist support frame and second and first leg support frames configured to support at least part of the body of the user, second and first thigh fastening portions configured to fix the second and first leg support frames to a thigh of the user, an IMU disposed within the base body, driving modules configured to generate a torque to be applied to a leg of the user, in which the driving modules are positioned between the waist support frame and the second and first leg support frames, an angle sensor configured to measure a rotation angle of the second and first leg support frames, a first distance sensor installed on the wearable device at a preset first angle and configured to calculate a first depth for a first position of a surrounding scene of the wearable device, a second distance sensor installed on the wearable device at a preset second angle and configured to calculate a second depth for a second position of the surrounding scene of the wearable device, and control modules including at least one processor configured to control the wearable device and a memory configured to store instructions executable by the at least one processor, in which, when executed by the at least one processor, the instructions cause the wearable device to at least calculate a first height based on the preset first angle and the first depth, calculate a second height based on the preset second angle and the second depth, generate a first depth value pattern based on the first height and the second height, and determine a first state of a walking terrain corresponding to the first depth value pattern based on the first depth value pattern.

Other features and aspects will be apparent from the following detailed description, drawings, and claims.

### BRIEF DESCRIPTION OF THE DRAWINGS

The above and other aspects, features, and advantages of certain embodiments of the present disclosure will be more apparent from the following detailed description, taken in conjunction with the accompanying drawings, in which:

FIG. 1 is a diagram illustrating an overview of a wearable device worn on the body of a user, according to an example embodiment;

FIG. 2 is a diagram illustrating an exercise management system including a wearable device and an electronic device, according to an example embodiment;

FIG. 3 is a rear schematic view of a wearable device according to an example embodiment;

FIG. 4 is a left side view of a wearable device according to an example embodiment;

FIGS. 5A and 5B are diagrams illustrating a configuration of a control system of a wearable device, according to an example embodiment;

FIG. 6 is a diagram illustrating an interaction between a wearable device and an electronic device, according to an example embodiment;

FIG. 7 is a diagram illustrating a configuration of an electronic device, according to an example embodiment;

FIG. 8A illustrates a distance sensor module including a distance sensor installed on a wearable device, according to an example embodiment;

FIG. 8B illustrates a distance sensor module disposed on a waist fastening portion, according to an example embodiment;

FIG. 9 is a flowchart illustrating a method of determining a state of a walking terrain, according to an example embodiment;

FIG. 10 is a flowchart illustrating a method of setting a region of interest (RoI) based on at least one of the left leg or the right leg of a user in an identified image, according to an example embodiment;

FIG. 11 illustrates a method of identifying the left leg or the right leg of a user in an image and setting an RoI based on the identified leg, according to an example embodiment;

FIG. 12 illustrates a method of setting an RoI based on a first image, according to an example embodiment;

FIG. 13A illustrates a depth value pattern generated when a state of a terrain is flat ground, according to an example embodiment;

FIG. 13B illustrates depth value patterns generated when a state of a terrain is uphill stairs, according to an example embodiment;

FIG. 13C illustrates depth value patterns generated when a state of a terrain is downhill stairs, according to an example embodiment;

FIG. 13D illustrates depth value patterns generated when a state of a terrain is an uphill road, according to an example embodiment;

FIG. 13E illustrates depth value patterns generated when a state of a terrain is a downhill road, according to an example embodiment;

FIG. 13F illustrates depth value patterns generated when a state of a terrain includes uphill stairs and flat ground, according to an example embodiment;

FIG. 13G illustrates depth value patterns generated when a state of a terrain includes a downhill slope and flat ground, according to an example embodiment;

FIG. 13H illustrates depth value patterns generated when a state of a terrain is an uphill road with a changing degree of slope, according to an example embodiment;

FIG. 13I illustrates depth value patterns generated when a state of a terrain is a downhill road with a changing degree of slope, according to an example embodiment;

FIG. 14A illustrates depth value patterns generated for a state of a terrain where upward obstacles are on flat ground, according to an example embodiment;

FIG. 14B illustrates depth value patterns generated for a state of a terrain where downward obstacles are on flat ground, according to an example embodiment;

FIG. 15 is a flowchart illustrating a method of determining a first state of a walking terrain corresponding to a first RoI based on a first reference depth value pattern, according to an example embodiment;

FIG. 16 is a flowchart illustrating a method of determining a first state of a walking terrain corresponding to a first RoI based on a second reference depth value pattern generated based on a first posture of a distance sensor, according to an example embodiment;

FIG. 17 is a flowchart illustrating a method of outputting a first notification associated with a first state, according to an example embodiment;

FIG. 18 is a flowchart illustrating a method of controlling a driving module based on a walking pattern of a user, according to an example embodiment;

FIG. 19 is a flowchart illustrating a method of controlling a driving module based on a walking speed of a user, according to an example embodiment;

FIG. 20 illustrates a method of determining a state of a walking terrain using a plurality of distance sensors, according to an example embodiment;

FIG. 21 is a flowchart illustrating a method of determining a state of a walking terrain using a plurality of distance sensors, according to an example embodiment;

FIG. 22 illustrates a method of determining postures of a plurality of distance sensors, according to an example embodiment; and

FIG. 23 is a flowchart illustrating a method of determining a state of a walking terrain based on postures of a plurality of distance sensors, according to an example embodiment.

### DETAILED DESCRIPTION

Hereinafter, various example embodiments of the present disclosure will be described with reference to the accompanying drawings. However, this is not intended to limit the present disclosure to specific embodiments, and it should be understood that various modifications, equivalents, and/or alternatives of the embodiments of the present disclosure are included.

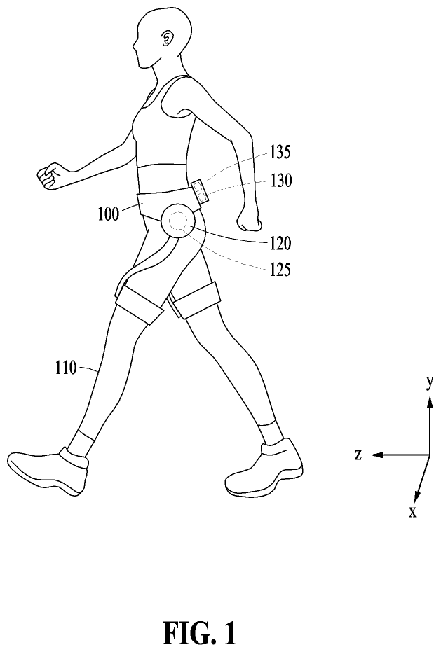

FIG. 1 is a diagram illustrating an overview of a wearable device worn on the body of a user, according to an embodiment.

Referring to FIG. 1, in an embodiment, a wearable device 100 may be a device worn on the body of a user 110 to assist the user 110 in walking, exercising, and/or working. In an embodiment, the wearable device 100 may be used to measure a physical ability (e.g., a walking ability, an exercise ability, or an exercise posture) of the user 110. In embodiments, the term “wearable device” may be replaced with a “wearable robot,” a “walking assistance device,” or an “exercise assistance device.” The user 110 may be a human or an animal but is not limited thereto. The wearable device 100 may be worn on the body (e.g., the lower body (the legs, ankles, knees, etc.), the upper body (the torso, arms, wrists, etc.), or the waist) of the user 110 to apply external force such as assistance force and/or resistance force to the body motion of the user 110. The assistance force may be force applied in the same direction as the body motion direction of the user 110, e.g., the force to assist the body motion of the user 110. The resistance force may be force applied in a direction that is opposite to the body motion direction of the user 110, e.g., the force hindering the body motion of the user 110. The term “resistance force” may also be referred to as an “exercise load.”

In an embodiment, the wearable device 100 may operate in a walking assistance mode for assisting the user 110 in walking. In the walking assistance mode, the wearable device 100 may assist the user 110 in walking by applying the assistance force generated by a driving module(s) 120 of the wearable device 100 to the body of the user 110. The wearable device 100 may allow the user 110 to walk independently or to walk for a long time by providing force required for walking of the user 110, to expand a walking ability of the user 110. The wearable device 100 may help improve an abnormal walking habit or gait posture of a walker.

In an embodiment, the wearable device 100 may operate in an exercise assistance mode for enhancing the exercise effect of the user 110. In the exercise assistance mode, the wearable device 100 may hinder the body motion of the user 110 or provide resistance to the body motion of the user 110 by applying the resistance force generated by the driving module 120 to the body of the user 110. When the wearable device 100 is a hip-type wearable device that is worn on the waist (or the pelvis) and the legs (e.g., the thighs) of the user 110, the wearable device 100 may provide an exercise load to the leg motion of the user 110 while being worn on the legs, thereby enhancing the exercise effect on the legs of the user 110. In an embodiment, the wearable device 100 may apply the assistance force to the body of the user 110 to assist the user 110 in exercising. For example, when a handicapped person or an elderly person wants to exercise wearing the wearable device 100, the wearable device 100 may provide the assistance force for assisting the body motion during an exercise process. In an embodiment, the wearable device 100 may provide the assistance force and the resistance force in combination for each exercise section or time section, in such a manner of providing the assistance force in some exercise sections and the resistance force in other exercise sections.

In an embodiment, the wearable device 100 may operate in a physical ability measurement mode for measuring a physical ability of the user 110. The wearable device 100 may measure motion information of the user 110 using sensors (e.g., an angle sensor 125 and an inertial measurement unit (IMU) 135) provided in the wearable device 100 while the user 110 is walking or exercising and may evaluate the physical ability of the user 110 based on the measured motion information. For example, a gait index or an exercise ability indicator (e.g., muscular strength, endurance, balance, or exercise motion) of the user 110 may be estimated through the motion information of the user 110 measured by the wearable device 100. The physical ability measurement mode may include an exercise posture measurement mode for measuring an exercise posture of the user 110.

In various embodiments of the present disclosure, for ease of description, the wearable device 100 is described as an example of a hip-type wearable device, as illustrated in FIG. 1, but embodiments are not limited thereto. As described above, the wearable device 100 may be worn on another body part (e.g., the upper arms, lower arms, hands, calves, and feet) other than the waist and legs (particularly, the thighs), and the shape and configuration of the wearable device 100 may vary depending on the body part on which the wearable device 100 is worn.

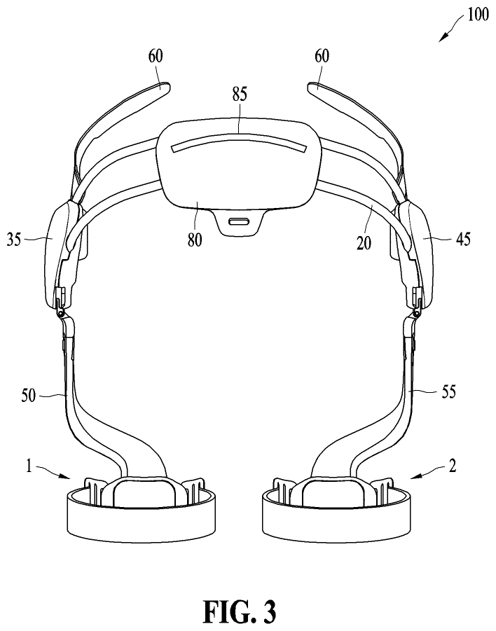

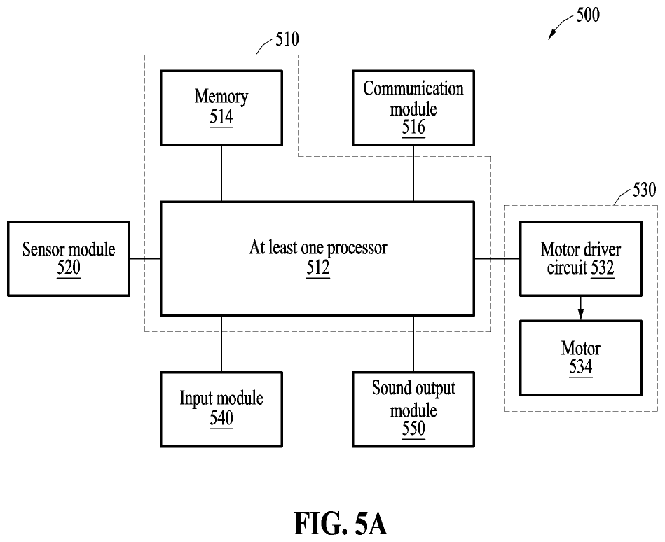

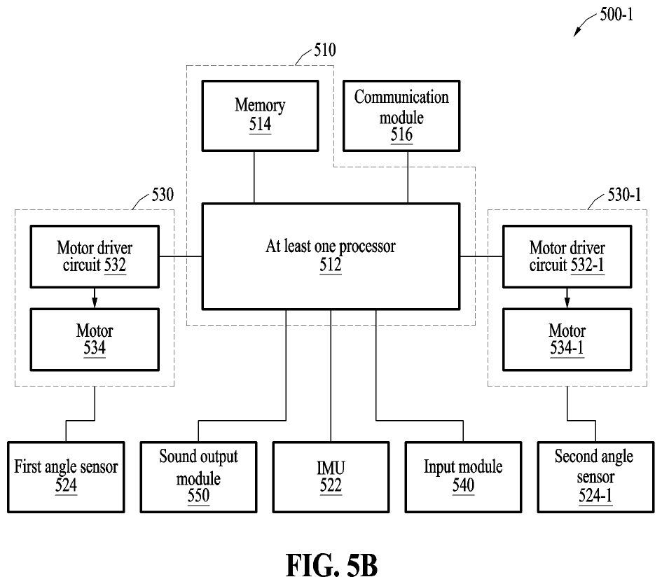

According to an embodiment, the wearable device 100 may include a support frame (e.g., second and first leg support frames 50 and 55 and a waist support frame 20 of FIG. 3) configured to support the body of the user 110 when the wearable device 100 is worn on the body of the user 110, a sensor module (e.g., a sensor module 520 of FIG. 5A) configured to obtain sensor data including motion information about the body motion (e.g., the leg motion and the upper body motion) of the user 110, the driving module 120 (e.g., second and first driving modules 35 and 45 of FIG. 3) configured to generate a torque to be applied to the legs of the user 110, and a control module 130 (e.g., a control module 510 of FIGS. 5A and 5B) configured to control the wearable device 100.

The sensor module may include the angle sensor 125 and the IMU 135. The angle sensor 125 may measure the rotation angle of a leg support frame of the wearable device 100 corresponding to a hip joint angle value of the user 110. The rotation angle of the leg support frame measured by the angle sensor 125 may be estimated as the hip joint angle value (or a leg angle value) of the user 110. The angle sensor 125 may include, for example, an encoder and/or a Hall sensor. In an embodiment, the angle sensor 125 may be present near each of the right hip joint and the left hip joint of the user 110. The IMU 135 may include an acceleration sensor and/or an angular velocity sensor and may measure a change in acceleration and/or angular velocity according to the motion of the user 110. The IMU 135 may measure, for example, an upper body motion value of the user 110 corresponding to a motion value of a waist support frame (or a base body (a base body 80 of FIG. 3)) of the wearable device 100. The motion value of the waist support frame measured by the IMU 135 may be estimated as the upper body motion value of the user 110.

In an embodiment, the control module 130 and the IMU 135 may be disposed within the base body (e.g., the base body 80 of FIG. 3) of the wearable device 100. The base body may be positioned on the lumbar region (an area of the lower back) of the user 110 while the user 110 is wearing the wearable device 100. The base body may be formed or attached to the outer side of the waist support frame of the wearable device 100. The base body may be mounted on the lumbar region of the user 110 to provide a cushioning feeling to the lower back of the user 110 and may support the lower back of the user 110 together with the waist support frame.

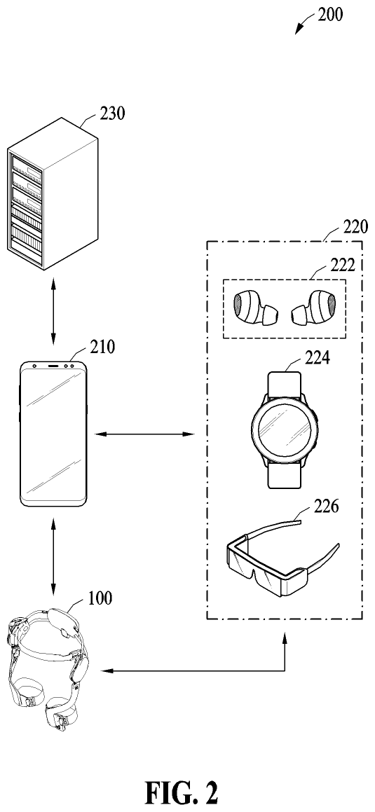

FIG. 2 is a diagram illustrating an exercise management system including a wearable device and an electronic device, according to an embodiment.

Referring to FIG. 2, an exercise management system 200 may include the wearable device 100 worn on the body of a user, an electronic device 210, another wearable device 220, and a server 230. In an embodiment, at least one (e.g., the other wearable device 220 or the server 230) of these devices may be omitted from the exercise management system 200, or one or more other devices (e.g., an exclusive controller device of the wearable device 100) may be added to the exercise management system 200.

In an embodiment, the wearable device 100 may be worn on the body of the user in the walking assistance mode to assist the motion of the user. For example, the wearable device 100 may be worn on the legs of the user to help the user in walking by generating the assistance force for assisting the leg motion of the user.

In an embodiment, the wearable device 100 may generate the resistance force for hindering the body motion of the user or the assistance force for assisting the body motion of the user and may apply the generated resistance force or assistance force to the body of the user to enhance the exercise effect of the user in the exercise assistance mode. In the exercise assistance mode, the user may select, through the electronic device 210, an exercise program (e.g., squat, split lunge, dumbbell squat, lunge and knee up, stretching, or the like) to perform using the wearable device 100 and/or the exercise intensity to be applied to the wearable device 100. The wearable device 100 may control a driving module of the wearable device 100 according to the exercise program selected by the user and may obtain sensor data including motion information of the user through a sensor module. The wearable device 100 may adjust the strength of the resistance force or assistance force applied to the user according to the exercise intensity selected by the user. For example, the wearable device 100 may control the driving module to generate the resistance force corresponding to the exercise intensity selected by the user.

In an embodiment, the wearable device 100 may be used to measure a physical ability of the user in interoperation with the electronic device 210. The wearable device 100 may operate in the physical ability measurement mode, which is a mode for measuring the physical ability of the user, under control by the electronic device 210, and may transmit sensor data obtained by the motion of the user in the physical ability measurement mode to the electronic device 210. The electronic device 210 may estimate the physical ability of the user by analyzing the sensor data received from the wearable device 100.

The electronic device 210 may communicate with the wearable device 100 and may remotely control the wearable device 100 or provide the user with state information about a state (e.g., a booting state, a charging state, a sensing state, or an error state) of the wearable device 100. The electronic device 210 may receive, from the wearable device 100, the sensor data obtained by a sensor in the wearable device 100 and may estimate the physical ability of the user or an exercise result based on the received sensor data. In an embodiment, when the user exercises wearing the wearable device 100, the wearable device 100 may obtain sensor data including motion information of the user using sensors and may transmit the obtained sensor data to the electronic device 210. The electronic device 210 may extract a motion value of the user from the sensor data and may evaluate an exercise posture of the user based on the extracted motion value. The electronic device 210 may provide the user with an exercise posture measured value and exercise posture evaluation information related to the exercise posture of the user through a graphical user interface (GUI).

In an embodiment, the electronic device 210 may execute a program (e.g., an application) configured to control the wearable device 100, and the user may adjust an operation or a set value (e.g., the magnitude of a torque output from a driving module (e.g., the second and first driving modules 35 and 45 of FIG. 3)) of the wearable device 100, the volume of audio output from a sound output module (e.g., a sound output module 550 of FIGS. 5A and 5B), or the brightness of a lighting unit (e.g., a lighting unit 85 of FIG. 3) through a corresponding program. The program executed by the electronic device 210 may provide a GUI for interaction with the user. The electronic device 210 may be a device in various forms. For example, the electronic device 210 may include a portable communication device (e.g., a smartphone), a computer device, an access point, a portable multimedia device, or a home appliance (e.g., a television, an audio device, or a projector device) but is not limited thereto.

According to an embodiment, the electronic device 210 may be connected to the server 230 using short-range wireless communication or cellular communication. The server 230 may receive, from the electronic device 210, user profile information of the user who uses the wearable device 100 and may store and manage the received user profile information. The user profile information may include, for example, information about at least one of the name, age, gender, height, weight, or body mass index (BMI). The server 230 may receive, from the electronic device 210, exercise history information about an exercise performed by the user and may store and manage the received exercise history information. The server 230 may provide the electronic device 210 with various exercise programs or physical ability measurement programs that may be provided to the user.

According to an embodiment, the wearable device 100 and/or the electronic device 210 may be connected to the other wearable device 220. The other wearable device 220 may include, for example, wireless earphones 222, a smart watch 224, or smart glasses 226 but is not limited thereto. In an embodiment, the smart watch 224 may measure a biosignal including heart rate information of the user and may transmit the measured biosignal to the electronic device 210 and/or the wearable device 100. The electronic device 210 may estimate the heart rate information (e.g., the current heart rate, maximum heart rate, and average heart rate) of the user based on the biosignal received from the smart watch 224 and may provide the estimated heart rate information to the user.

In an embodiment, the exercise result information, physical ability information, and/or exercise posture evaluation information evaluated by the electronic device 210 may be transmitted to the other wearable device 220 and provided to the user through the other wearable device 220. State information of the wearable device 100 may also be transmitted to the other wearable device 220 and provided to the user through the other wearable device 220. In an embodiment, the wearable device 100, the electronic device 210, and the other wearable device 220 may be connected to each other through wireless communication (e.g., Bluetooth communication or wireless fidelity (Wi-Fi) communication).

In an embodiment, the wearable device 100 may provide (or output) feedback (e.g., visual feedback, auditory feedback, or haptic feedback) corresponding to the state of the wearable device 100 according to a control signal received from the electronic device 210. For example, the wearable device 100 may provide visual feedback through the lighting unit (e.g., the lighting unit 85 of FIG. 3) and may provide auditory feedback through the sound output module (e.g., the sound output module 550 of FIGS. 5A and 5B). The wearable device 100 may include a haptic module and may provide haptic feedback as vibration to the body of the user through the haptic module. The electronic device 210 may also provide (or output) feedback (e.g., visual feedback, auditory feedback, or haptic feedback) corresponding to the state of the wearable device 100.

In an embodiment, the electronic device 210 may present a personalized exercise goal to the user in the exercise assistance mode. The personalized exercise goal may include respective target amounts of exercise for exercise types (e.g., strength exercise, balance exercise, and aerobic exercise) desired by the user, determined by the electronic device 210 and/or the server 230. When the server 230 determines target amounts of exercise, the server 230 may transmit information about the determined target amounts of exercise to the electronic device 210. The electronic device 210 may personalize and present the target amounts of exercise for the exercise types, such as strength exercise, aerobic exercise, and balance exercise, according to a desired exercise program (e.g., squat, split lunge, or a lunge and knee up) and/or the physical characteristics (e.g., the age, height, weight, and BMI) of the user. The electronic device 210 may display a GUI screen displaying the target amounts of exercise for the respective exercise types on a display.

In an embodiment, the electronic device 210 and/or the server 230 may include a database in which information about a plurality of exercise programs to be provided to the user through the wearable device 100 is stored. To achieve an exercise goal of the user, the electronic device 210 and/or the server 230 may recommend an exercise program suitable for the user. The exercise goal may include, for example, at least one of muscle strength improvement, physical strength improvement, cardiovascular endurance improvement, core stability improvement, flexibility improvement, or symmetry improvement. The electronic device 210 and/or the server 230 may store and manage the exercise program performed by the user, the results of performing the exercise program, and the like.

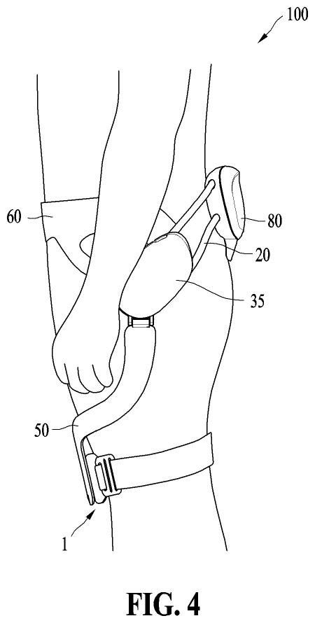

FIG. 3 is a rear schematic view of a wearable device according to an embodiment. FIG. 4 is a left side view of a wearable device, according to an embodiment.

Referring to FIGS. 3 and 4, the wearable device 100 according to an embodiment may include the base body 80, the waist support frame 20, the second and first driving modules 35 and 45, the second and first leg support frames 50 and 55, second and first thigh fastening portions 1 and 2, and a waist fastening portion 60. The base body 80 may include the lighting unit 85. In an embodiment, at least one (e.g., the lighting unit 85) of these components may be omitted from the wearable device 100, or one or more other components (e.g., a haptic module) may be added to the wearable device 100.

The base body 80 may be positioned on the lumbar region of a user while the user is wearing the wearable device 100. The base body 80 may be mounted on the lumbar region of the user to provide a cushioning feeling to the lower back of the user and may support the lower back of the user. The base body 80 may be hung on the hip region (an area of the hips) of the user to prevent or reduce chances of the wearable device 100 from being separated downward due to gravity while the user is wearing the wearable device 100. The base body 80 may distribute a portion of the weight of the wearable device 100 to the lower back of the user while the user is wearing the wearable device 100. The base body 80 may be connected, directly or indirectly, to the waist support frame 20. Waist support frame-connecting elements (not shown) to be connected, directly or indirectly, to the waist support frame 20 may be provided at both end portions of the base body 80.

In an embodiment, the lighting unit 85 may be disposed on the outer side of the base body 80. The lighting unit 85 may include a light source (e.g., a light-emitting diode (LED)). The lighting unit 85 may emit light under the control by a control module (not shown) (e.g., the control module 510 of FIGS. 5A and 5B). In some embodiments, the control module may control the lighting unit 85 to provide (or output) visual feedback corresponding to the state of the wearable device 100 to the user through the lighting unit 85.

The waist support frame 20 may extend from both end portions of the base body 80. The lumbar region of the user may be accommodated inside of the waist support frame 20. The waist support frame 20 may include at least one rigid body beam. Each beam may be in a curved shape having a preset curvature to enclose the lumbar region of the user. The waist fastening portion 60 may be connected, directly or indirectly, to an end portion of the waist support frame 20. The second and first driving modules 35 and 45 may be connected, directly or indirectly, to the waist support frame 20.

In an embodiment, the control module, an IMU (not shown) (e.g., the IMU 135 of FIG. 1 or an IMU 522 of FIG. 5B), a communication module (not shown) (e.g., a communication module 516 of FIGS. 5A and 5B), and a battery (not shown) may be disposed inside of the base body 80. The base body 80 may protect the control module, the IMU, the communication module, and the battery. The control module may generate a control signal for controlling the operation of the wearable device 100. The control module may include a control circuit including a processor configured to control actuators of the second and first driving modules 35 and 45 and a memory. The control module may further include a power supply module (not shown) to supply power from a battery to each of the components of the wearable device 100.

In an embodiment, the wearable device 100 may include a sensor module (not shown) (e.g., the sensor module 520 of FIG. 5A) configured to obtain sensor data from at least one sensor. The sensor module may obtain sensor data that changes according to the motion of the user. In an embodiment, the sensor module may obtain sensor data including motion information of the user and/or motion information of the components of the wearable device 100. The sensor module may include, for example, an IMU (e.g., the IMU 135 of FIG. 1 or the IMU 522 of FIG. 5B) configured to measure an upper body motion value of the user or a motion value of the waist support frame 20 and an angle sensor (e.g., the angle sensor 125 of FIG. 1 or a first angle sensor 524 and a second angle sensor 524-1 of FIG. 5B) configured to measure a hip joint angle value of the user or a motion value of the second and first leg support frames 50 and 55 but is not limited thereto. For example, the sensor module may further include at least one of a position sensor, a temperature sensor, a biosignal sensor, and a proximity sensor.

The waist fastening portion 60 may be connected, directly or indirectly, to the waist support frame 20 to fix the waist support frame 20 to the waist of the user. The waist fastening portion 60 may include, for example, a pair of belts.

The second and first driving modules 35 and 45 may generate external force (or a torque) to be applied to the body of the user based on the control signal generated by the control module. For example, the second and first driving modules 35 and 45 may generate the assistance force or resistance force to be applied to the legs of the user. In an embodiment, the second and first driving modules 35 and 45 may include the first driving module 45 disposed in a position corresponding to a position of the right hip joint of the user and the second driving module 35 disposed in a position corresponding to a position of the left hip joint of the user. The first driving module 45 may include a first actuator and a first joint member, and the second driving module 35 may include a second actuator and a second joint member. The first actuator may provide power to be transmitted to the first joint member, and the second actuator may provide power to be transmitted to the second joint member. The first actuator and the second actuator may each include a motor configured to generate power (or torque) by receiving electric power from the battery. When the motor is supplied with electric power and driven, the motor may generate force (the assistance force) for assisting the body motion of the user or force (the resistance force) for hindering the body motion of the user. In an embodiment, the control module, comprising circuitry, may adjust the strength and direction of the force generated by the motor by adjusting the voltage and/or current supplied to the motor.

In an embodiment, the first joint member and the second joint member may receive power from the first actuator and the second actuator, respectively, and may apply external force to the body of the user based on the received power. The first joint member and the second joint member may be disposed at positions corresponding to the joints of the user, respectively. One side of the first joint member may be connected, directly or indirectly, to the first actuator, and the other side of the first joint member may be connected, directly or indirectly, to the first leg support frame 55. The first joint member may be rotated by the power received from the first actuator. An encoder or a hall sensor that may operate as an angle sensor configured to measure the rotation angle of the first joint member (corresponding to the joint angle of the user) may be disposed on one side of the first joint member. One side of the second joint member may be connected, directly or indirectly, to the second actuator, and the other side of the second joint member may be connected, directly or indirectly, to the second leg support frame 50. The second joint member may be rotated by the power received from the second actuator. The encoder or the hall sensor that may operate as an angle sensor configured to measure the rotation angle of the second joint member may be disposed on one side of the second joint member.

In an embodiment, the first actuator may be disposed in a lateral direction of the first joint member, and the second actuator may be disposed in a lateral direction of the second joint member. A rotation axis of the first actuator and a rotation axis of the first joint member may be spaced apart from each other, and a rotation axis of the second actuator and a rotation axis of the second joint member may also be spaced apart from each other. However, embodiments are not limited thereto, and an actuator and a joint member may share a rotation axis. In an embodiment, each actuator may be spaced apart from a corresponding joint member. In this case, the second and first driving modules 35 and 45 may further include a power transmission module (not shown) configured to transmit power from the actuator to the joint member. The power transmission module may be a rotary body, such as a gear, or a longitudinal member, such as a wire, a cable, a string, a spring, a belt, or a chain. However, the scope of the embodiment is not limited by the positional relationship between an actuator and a joint member and the power transmission structure described above.

In an embodiment, the second and first leg support frames 50 and 55 may support the leg (e.g., the thigh) of the user when the wearable device 100 is worn on the legs of the user. For example, the second and first leg support frames 50 and 55 may transmit power (torque) generated by the second and first driving modules 35 and 45 to the thighs of the user, and the power may act as external force to be applied to the motion of the legs of the user. As one end portion of each of the second and first leg support frames 50 and 55 is connected, directly or indirectly, to a joint member to rotate and the other end portions of the second and first leg support frames 50 and 55 are connected, directly or indirectly, to the second and first thigh fastening portions 1 and 2, the second and first leg support frames 50 and 55 may transmit the power generated by the second and first driving modules 35 and 45 to the thighs of the user while supporting the thighs of the user. For example, the second and first leg support frames 50 and 55 may push or pull the thighs of the user. The second and first leg support frames 50 and 55 may extend in a longitudinal direction of the thighs of the user. The second and first leg support frames 50 and 55 may be bent to wrap around at least a portion of the circumference of the thighs of the user. The second and first leg support frames 50 and 55 may include the first leg support frame 55 to support the right leg of the user, and the second leg support frame 50 to support the left leg of the user.

The second and first thigh fastening portions 1 and 2 may be connected, directly or indirectly, to the second and first leg support frames 50 and 55 and may fix the second and first leg support frames 50 and 55 to the thighs. The second and first thigh fastening portions 1 and 2 may include the first thigh fastening portion 2 to fix the first leg support frame 55 to the right thigh of the user, and the second thigh fastening portion 1 to fix the second leg support frame 50 to the left thigh of the user.

In an embodiment, the first thigh fastening portion 2 may include a first cover, a first fastening frame, and a first strap, and the second thigh fastening portion 1 may include a second cover, a second fastening frame, and a second strap. The first cover and the second cover may apply torques generated by the second and first driving modules 35 and 45 to the thighs of the user. The first cover and the second cover may be disposed on one side of the thighs of the user to push or pull the thighs of the user. The first cover and the second cover may be disposed on the front surfaces of the thighs of the user. The first cover and the second cover may be disposed in the circumferential directions of the thighs of the user. The first cover and the second cover may extend to both sides from the other end portions of the second and first leg support frames 50 and 55 and may include curved surfaces corresponding to the thighs of the user. One end of each of the first cover and the second cover may be connected, directly or indirectly, to the fastening frame, and the other ends thereof may be connected, directly or indirectly, to the straps.

The first fastening frame and the second fastening frame may be disposed, for example, to surround at least some portions of the circumferences of the thighs of the user, thereby preventing or reducing chances of the thighs of the user from being separated from the second and first leg support frames 50 and 55. The first fastening frame may have a fastening structure that connects the first cover to the first strap, and the second fastening frame may have a fastening structure that connects the second cover to the second strap.

The first strap may enclose the remaining portion of the circumference of the right thigh of the user that is not covered by the first cover and the first fastening frame, and the second strap may enclose the remaining portion of the circumference of the left thigh of the user that is not covered by the second cover and the second fastening frame. The first strap and the second strap may include, for example, an elastic material (e.g., a band).

FIGS. 5A and 5B are diagrams illustrating a configuration of a control system of a wearable device, according to an embodiment.

Referring to FIG. 5A, the wearable device 100 may be controlled by a control system 500. The control system 500 may include the control module 510 comprising circuitry, the communication module 516, the sensor module 520, a driving module 530, an input module 540, and the sound output module 550. In an embodiment, at least one (e.g., the sound output module 550) of these components may be omitted from the control system 500, or one or more other components (e.g., a haptic module) may be added to the control system 500.

The driving module 530 may include a motor 534 to generate power (e.g., torque) and a motor driver circuit 532 to drive the motor 534. Although FIG. 5A illustrates the driving module 530 including one motor driver circuit 532 and one motor 534, this is only an example. Referring to FIG. 5B, a control system 500-1 may include a plurality of (e.g., two or more) motor driver circuits 532 and 532-1 and a plurality of (e.g., two or more) motors 534 and 534-1. The driving module 530 including the motor driver circuit 532 and the motor 534 may correspond to the first driving module 45 of FIG. 3, and a driving module 530-1 including the motor driver circuit 532-1 and the motor 534-1 may correspond to the second driving module 35 of FIG. 3. The following descriptions of the motor driver circuit 532 and the motor 534 may also be respectively applicable to the motor driver circuit 532-1 and the motor 534-1 illustrated in FIG. 5B.

Referring back to FIG. 5A, the sensor module 520 may include a sensor circuit including at least one sensor. The sensor module 520 may obtain sensor data including motion information of a user or motion information of the wearable device 100. The sensor module 520 may transmit the obtained sensor data to the control module 510. The sensor module 520 may include the IMU 522 and an angle sensor (e.g., the first angle sensor 524 and the second angle sensor 524-1) as illustrated in FIG. 5B. The IMU 522 may measure an upper body motion value of the user. For example, the IMU 522 may sense X-axis, Y-axis, and Z-axis accelerations and X-axis, Y-axis, and Z-axis angular velocities according to the motion of the user. The IMU 522 may be used to measure, for example, at least one of a forward or backward tilt, a left or right tilt, or rotation of the body of the user. In addition, the IMU 522 may obtain motion values (e.g., acceleration values and angular velocity values) of a waist support frame (e.g., the waist support frame 20 of FIG. 3) of the wearable device 100. The motion values of the waist support frame may correspond to upper body motion values of the user.

The angle sensor may measure a hip joint angle value according to the motion of the legs of the user. Sensor data that may be measured by the angle sensor may include, for example, a hip joint angle value of the right leg., a hip joint angle value of the left leg, and information on a direction of the motion of the legs. For example, the first angle sensor 524 of FIG. 5B may obtain the hip joint angle value of the right leg of the user, and the second angle sensor 524-1 may obtain the hip joint angle value of the left leg of the user. The first angle sensor 524 and the second angle sensor 524-1 may each include, for example, an encoder and/or a hall sensor. Furthermore, the angle sensor may obtain motion values of the second and first leg support frames 50 and 55 of the wearable device 100. For example, the first angle sensor 524 may obtain a motion value of the first leg support frame 55 and the second angle sensor 524-1 may obtain a motion value of the second leg support frame 50. The motion values of the second and first leg support frames 50 and 55 may correspond to hip joint angle values.

In an embodiment, the sensor module 520 may further include at least one of a position sensor configured to obtain a position value of the wearable device 100, a proximity sensor configured to sense the proximity of an object, a biosignal sensor configured to detect a biosignal of the user, or a temperature sensor configured to measure ambient temperature.

The input module 540 may receive a command or data to be used by another component (e.g., at least one processor 512) of the wearable device 100 from the outside (e.g., the user) of the wearable device 100. The input module 540 may include an input component circuit. The input module 540 may include, for example, a key (e.g., a button) or a touch screen.

The sound output module 550 may output a sound signal to the outside of the wearable device 100. The sound output module 550 may provide auditory feedback to the user. For example, the sound output module 550 may include a speaker for playing a guiding sound signal (e.g., a driving start sound, an operation error alarm, or an exercise start alarm), music content, or a guiding voice for auditorily informing predetermined information (e.g., exercise result information or exercise posture evaluation information).

In an embodiment, the control system 500 may further include a battery (not shown) configured to supply power to each component of the wearable device 100. The wearable device 100 may convert the power of the battery into power suitable for operating voltage of each component of the wearable device 100 and may supply the converted power to each component.

The driving module 530 may generate external force to be applied to the legs of the user under the control by the control module 510. The driving module 530 may generate a torque to be applied to the legs of the user based on a control signal generated by the control module 510. The control module 510, comprising processing circuitry, may control to transmit the control signal to the motor driver circuit 532. The motor driver circuit 532 may control the operation of the motor 534 by generating a current signal (or a voltage signal) corresponding to the control signal and supplying the generated current signal (or a voltage signal) to the motor 534. In some cases, the current signal may not be supplied to the motor 534. When the motor 534 is supplied with the current signal and driven, the motor 534 may generate a torque for assistance force for assisting the leg motion of the user or resistance force for hindering the leg motion of the user.

The control module 510 may control the overall operation of the wearable device 100 and may generate a control signal for controlling each component (e.g., the communication module 516 or the driving module 530). The control module 510 may include the at least one processor 512, comprising processing circuitry, and a memory 514.

The at least one processor 512 may execute, for example, software to control at least one other component (e.g., a hardware or software component) of the wearable device 100 connected, directly or indirectly, to the at least one processor 512 and may perform a variety of data processing or computation. The software may include an application for providing a GUI. According to an embodiment, as at least a part of data processing or computation, the at least one processor 512 may store instructions or data received from another component (e.g., the communication module 516) in the memory 514, process the instructions or the data stored in the memory 514, and store result data in the memory 514. According to an embodiment, the at least one processor 512 may include a main processor (e.g., a central processing unit (CPU) or an application processor (AP)) or an auxiliary processor (e.g., a graphics processing unit (GPU), a neural processing unit (NPU), an image signal processor (ISP), a sensor hub processor, or a communication processor (CP)) that is operable independently of, or in conjunction with the main processor. The auxiliary processor may be implemented separately from the main processor or as a part of the main processor.

The memory 514 may store a variety of data used by at least one component (e.g., the at least one processor 512) of the control module 510. The variety of data may include, for example, software, sensor data, and input data or output data for instructions related thereto. The memory 514 may include a volatile memory or a non-volatile memory (e.g., random-access memory (RAM), dynamic RAM (DRAM), or static RAM (SRAM)).

The communication module 516 may support establishing a direct (e.g., wired) communication channel or a wireless communication channel between the control module 510 and another component of the wearable device 100 or an external electronic device (e.g., the electronic device 210 or the other wearable device 220 of FIG. 2), and performing communication via the established communication channel. The communication module 516 may include a communication circuit configured to perform a communication function. For example, the communication module 516 may receive a control signal from an electronic device (e.g., the electronic device 210) and may transmit the sensor data obtained by the sensor module 520 to the electronic device. According to an embodiment, the communication module 516 may include one or more CPs (not shown) that are operable independently of the at least one processor 512 and that support direct (e.g., wired) communication or wireless communication. According to an embodiment, the communication module 516 may include a wireless communication module (e.g., a cellular communication module, a short-range wireless communication module, or a global navigation satellite system (GNSS) communication module) and/or a wired communication module. A corresponding one of these communication modules may communicate with another component of the wearable device 100 and/or an external electronic device via a short-range communication network, such as Bluetooth, Wi-Fi, or infrared data association (IrDA), or a long-range communication network, such as a legacy cellular network, a fifth-generation (5G) network, a next-generation communication network, the Internet, or a computer network (e.g., a local area network (LAN) or a wide area network (WAN)).

In an embodiment, the control systems 500 and 500-1 may further include a haptic module (not shown). The haptic module may provide haptic feedback to the user under the control by the at least one processor 512. The haptic module may convert an electrical signal into a mechanical stimulus (e.g., vibration or movement) or an electrical stimulus, which may be recognized by the user via their tactile sensation or kinesthetic sensation. The haptic module may include a motor, a piezoelectric element, or an electrical stimulation device. In an embodiment, the haptic module may be positioned in at least one of a base body (e.g., the base body 80), the first thigh fastening portion 2, or the second thigh fastening portion 1.

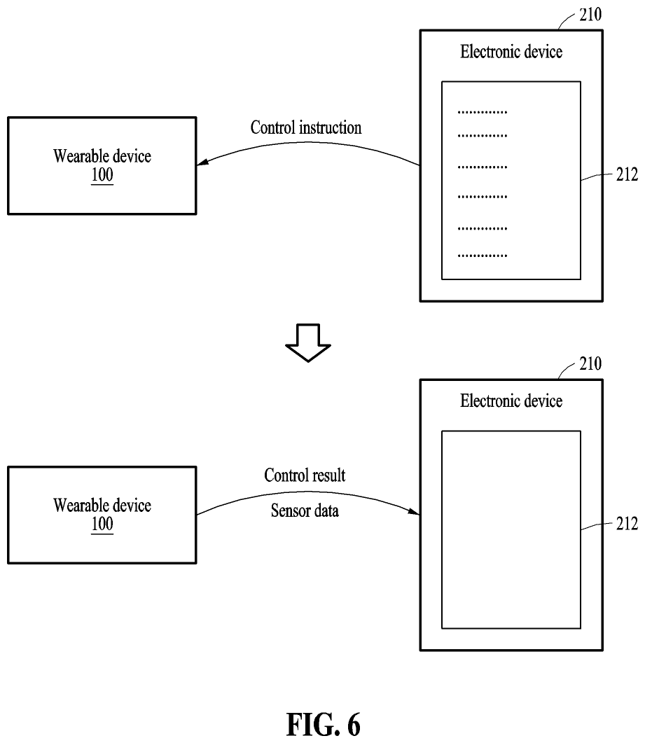

FIG. 6 is a diagram illustrating an interaction between a wearable device and an electronic device, according to an embodiment.

Referring to FIG. 6, the wearable device 100 may communicate with the electronic device 210. For example, the electronic device 210 may be a user terminal of a user who uses the wearable device 100 or a controller device dedicated to the wearable device 100. According to an embodiment, the wearable device 100 and the electronic device 210 may be connected to each other through short-range wireless communication (e.g., Bluetooth communication or Wi-Fi communication).

In an embodiment, the electronic device 210 may identify a state of the wearable device 100 or execute an application to control or operate the wearable device 100. A screen of a user interface (UI) may be displayed to control an operation of the wearable device 100 or determine an operation mode of the wearable device 100 on a display 212 of the electronic device 210 through the execution of the application. The UI may be, for example, a GUI.

In an embodiment, the user may input an instruction for controlling the operation of the wearable device 100 (e.g., an execution instruction to a walking assistance mode, an exercise assistance mode, or a physical ability measurement mode) or change settings of the wearable device 100 through a GUI screen on the display 212 of the electronic device 210. The electronic device 210 may generate a control instruction (or a control signal) corresponding to an operation control instruction or a setting change instruction input by the user and transmit the generated control instruction to the wearable device 100. The wearable device 100 may operate according to the received control instruction and transmit a control result according to the control instruction and/or sensor data measured by the sensor module of the wearable device 100 to the electronic device 210. The electronic device 210 may provide the user with result information (e.g., walking ability information, exercise ability information, or exercise posture evaluation information) derived by analyzing the control result and/or the sensor data through the GUI screen.

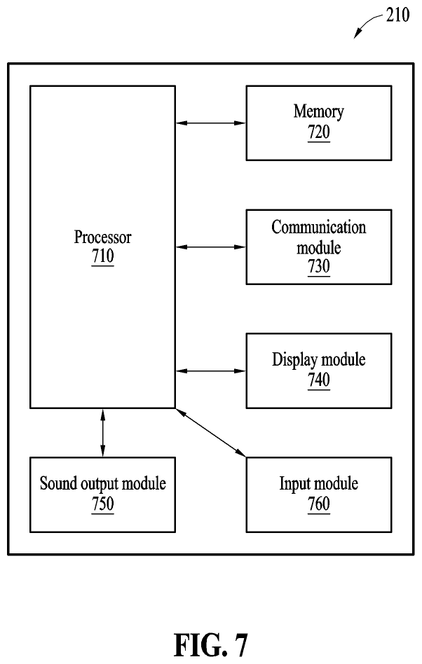

FIG. 7 is a diagram illustrating a configuration of an electronic device, according to an embodiment.

Referring to FIG. 7, the electronic device 210 may include a processor 710, a memory 720, a communication module 730, a display module 740, a sound output module 750, and an input module 760. In an embodiment, at least one (e.g., the sound output module 750) of these components may be omitted from the electronic device 210, or one or more other components (e.g., a sensor module and a battery) may be added to the electronic device 210.

The processor 710 may control at least one other component (e.g., a hardware or software component) of the electronic device 210 and may perform a variety of data processing or computation. According to an embodiment, as at least a part of data processing or computation, the processor 710 may store instructions or data received from another component (e.g., the communication module 730) in the memory 720, process the instructions or the data stored in the memory 720, and store result data in the memory 720.

According to an embodiment, the processor 710 may include a main processor (e.g., a CPU or an AP) or an auxiliary processor (e.g., a GPU, an NPU, an ISP, a sensor hub processor, or a CP) that is operable independently of, or in conjunction with the main processor.

The memory 720 may store a variety of data used by at least one component (e.g., the processor 710 or the communication module 730) of the electronic device 210. The data may include, for example, a program (e.g., an application), and input data or output data for instructions related thereto. The memory 720 may include at least one instruction executable by the processor 710. The memory 720 may include a volatile memory or a non-volatile memory.

The communication module 730 may support establishing a direct (e.g., wired) communication channel or a wireless communication channel between the electronic device 210 and another electronic device (e.g., the wearable device 100, the other wearable device 220, and the server 230), and performing communication via the established communication channel. The communication module 730 may include a communication circuit configured to perform a communication function. The communication module 730 may include one or more CPs that are operable independently of the processor 710 (e.g., an AP) and that support direct (e.g., wired) communication or wireless communication. According to an embodiment, the communication module 730 may include a wireless communication module configured to perform wireless communication (e.g., a Bluetooth communication module, a cellular communication module, a Wi-Fi communication module, or a GNSS communication module) or a wired communication module (e.g., a LAN communication module or a power line communication (PLC) module). For example, the communication module 730 may transmit a control instruction to the wearable device 100 and may receive, from the wearable device 100, at least one of sensor data including body motion information of the user who is wearing the wearable device 100, state data of the wearable device 100, or control result data corresponding to the control instruction.

The display module 740 may visually provide information to the outside (e.g., the user) of the electronic device 210. The display module 740 may include, for example, a liquid crystal display (LCD) or an organic light-emitting diode (OLED) display, a hologram device, or a projector device. The display module 740 may further include a control circuit to control the driving of a display. In an embodiment, the display module 740 may further include a touch sensor set to sense a touch or a pressure sensor set to sense the intensity of force generated by the touch.

The sound output module 750 may output a sound signal to the outside of the electronic device 210. The sound output module 750 may include a guiding sound signal (e.g., a driving start sound or an operation error notification sound) based on a state of the wearable device 100 and a speaker for playing music content or a guiding voice. When it is determined that the wearable device 100 is not properly worn on the body of the user, the sound output module 750 may output a guiding voice for informing the user is wearing the wearable device 100 abnormally or for guiding the user to wear the wearable device 100 normally. The sound output module 750 may output, for example, a guiding voice corresponding to exercise evaluation information or exercise result information obtained by evaluating an exercise of the user.

The input module 760 may receive a command or data to be used by a component (e.g., the processor 710) of the electronic device 210 from the outside (e.g., the user) of the electronic device 210. The input module 760 may include an input component circuit and receive a user input. The input module 760 may include, for example, a key (e.g., a button) or a touch screen.

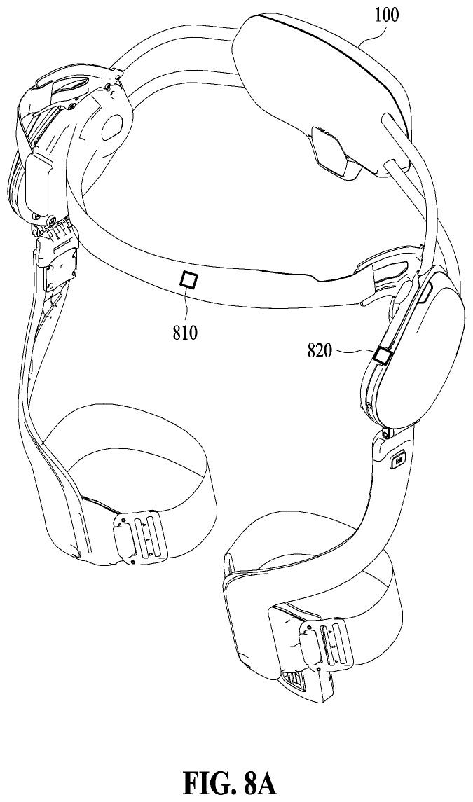

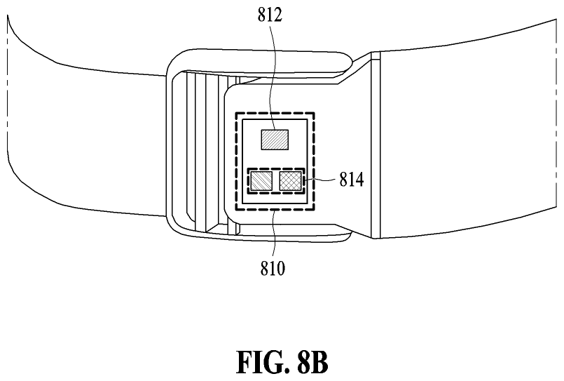

FIG. 8A illustrates a distance sensor module including a distance sensor installed on a wearable device, according to an embodiment.

According to an embodiment, the wearable device 100 may include the distance sensor module. For example, the distance sensor module may include one or more distance sensors. The distance sensors may be time of flight (ToF) sensors. The distance sensors may be stereo cameras. For example, the distance sensor module may include an auxiliary IMU. The auxiliary IMU may determine the posture of the distance sensor module or the distance sensors.

According to an embodiment, the distance sensor module may include a first distance sensor module 810 disposed on the waist fastening portion 60. The first distance sensor module 810 may be disposed on the waist fastening portion 60 so that the operation of the distance sensors in the first distance sensor module 810 is not interrupted even while a user is waking while wearing the wearable device 100.

According to an embodiment, the distance sensor module may include a second distance sensor module 820 disposed on the second driving module 35. The distance sensor module may be disposed on the second driving module 35 so that the operation of the distance sensors in the distance sensor module is not interrupted even while the user is walking while wearing the wearable device 100. The second distance sensor module 820 may be disposed on a position (e.g., a housing of the second driving module 35) that does not shake significantly, even when the second driving module 35 generates a torque. The second distance sensor module 820 may be disposed on the second driving module 35 so that the angle of view of the distance sensors of the second distance sensor module 820 is secured.

FIG. 8B illustrates a distance sensor module disposed on a waist fastening portion, according to an embodiment.

According to an embodiment, the first distance sensor module 810 may be disposed on the waist fastening portion 60. For example, the first distance sensor module 810 may be disposed on a buckle of the waist fastening portion 60.

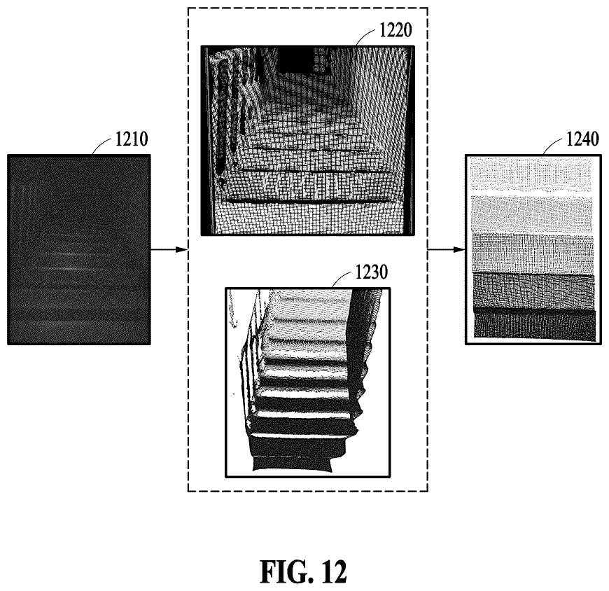

According to an embodiment, the first distance sensor module 810 may include a distance sensor 814. The distance sensor 814 may calculate a distance to a surrounding scene (e.g., front) of the wearable device 100. For example, the distance sensor 814 may include a transmitter (Tx) for the transmission of a signal and a receiver (Rx) for the reception of a signal. The distance sensor 814 may calculate a distance to an object that reflects a signal by calculating a ToF of the received signal. For example, the distance sensor 814 may generate an image of a scene. Each pixel in the image generated by the distance sensor 814 may include distance information of a point of an object corresponding to a pixel. The image generated by the distance sensor 814 is described in detail below with reference to FIG. 12.

According to an embodiment, the first distance sensor module 810 may include an auxiliary IMU 812. The auxiliary IMU 812 may measure the posture of the auxiliary IMU 812. The measured posture may be used as the posture of the first distance sensor module 810 or the distance sensor 814.

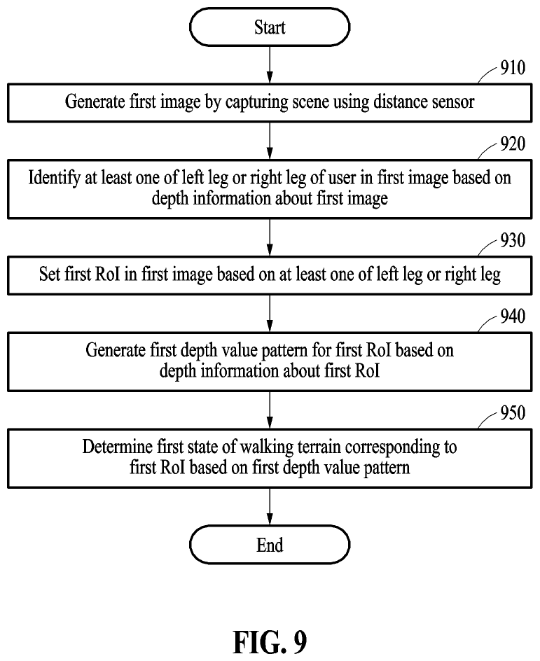

FIG. 9 is a flowchart illustrating a method of determining a state of a walking terrain, according to an embodiment.

Operations 910 to 950 below may be performed by a wearable device (e.g., the wearable device 100 of FIG. 1). For example, operations 910 to 950 may be performed by a control module (e.g., the control module 130 of FIG. 1 or the control module 510 of FIG. 5A) including at least one processor (e.g., the at least one processor 512 of FIG. 5) configured to control the wearable device and a memory (e.g., the memory 514 of FIG. 5) configured to store instructions executable by the at least one processor.

In operation 910, the wearable device may generate a first image by capturing a scene using a distance sensor (e.g., the distance sensor 814 of FIG. 8). For example, the distance sensor may generate a first image by capturing a scene corresponding to a field of view (FoV). For example, a walking terrain and the left leg or the right leg of a user who is walking may appear in the scene corresponding to the FoV of the distance sensor.

According to an embodiment, each pixel of the first image may include distance information about a corresponding point in the captured scene. For example, the distance sensor may determine distance information about a pixel using a ToF for the corresponding point in the captured scene. For example, the first image may be a depth map. For example, the distance information may include an intensity value for each pixel. For example, the distance information may include a depth value for each pixel.

In operation 920, the wearable device may identify at least one of the left leg or the right leg of the user in the first image based on depth information about the first image. For example, the wearable device may identify at least one of the left leg or the right leg of the user in the first image by determining whether the depth information corresponding to the left leg or the right leg appears in a preset area (e.g., a lower portion of the first image) of the first image in which the legs of the user are likely to appear.

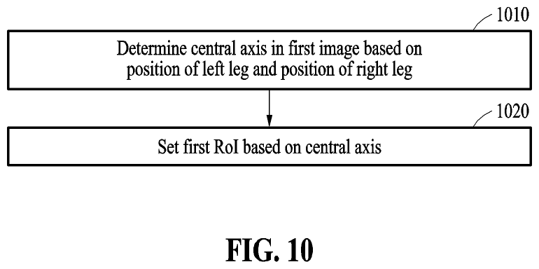

In operation 930, the wearable device may set a first region of interest (RoI) in the first image based on at least one of the left leg or the right leg. The terrain on which the user tries to walk may be in front of the user, especially in front of the legs. As the first RoI, an expected walking direction may be set to the front of the legs of the user. When the first RoI is set in the expected walking direction, a state of the terrain may be determined in advance. Since data is processed only for the first RoI rather than the entire first image, data throughput and processing time may be reduced compared to processing data for the entire first image. A method of setting the first RoI is described in detail below with reference to FIG. 10.

In operation 940, the wearable device may generate a first depth value pattern for the first RoI based on depth information about the first RoI.

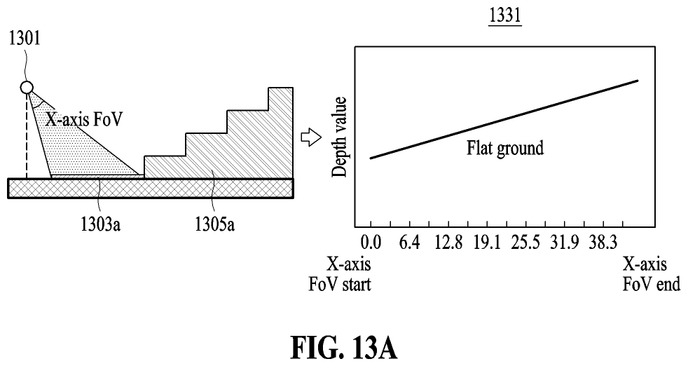

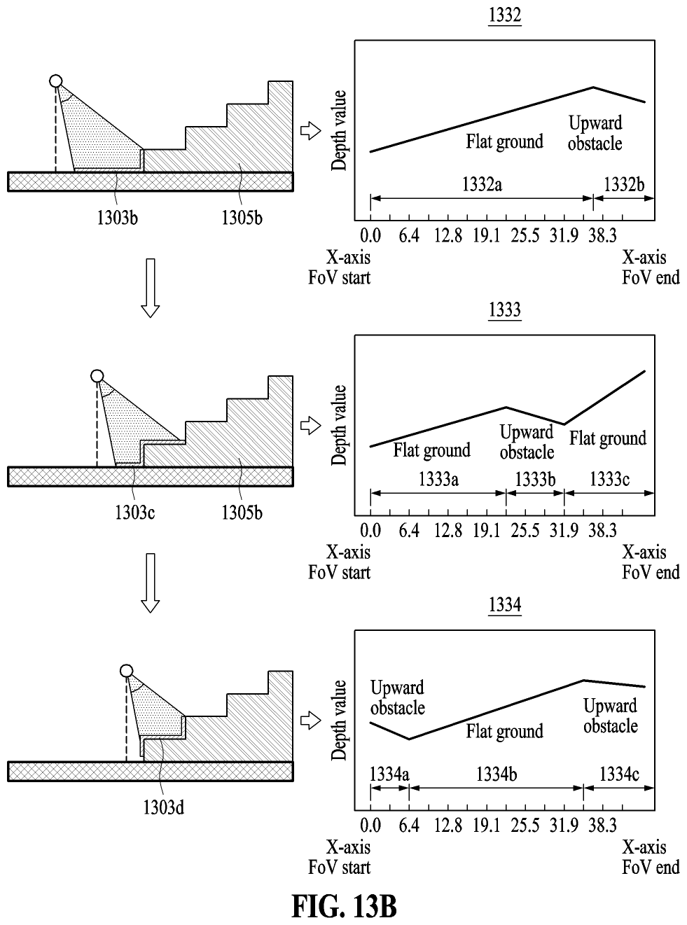

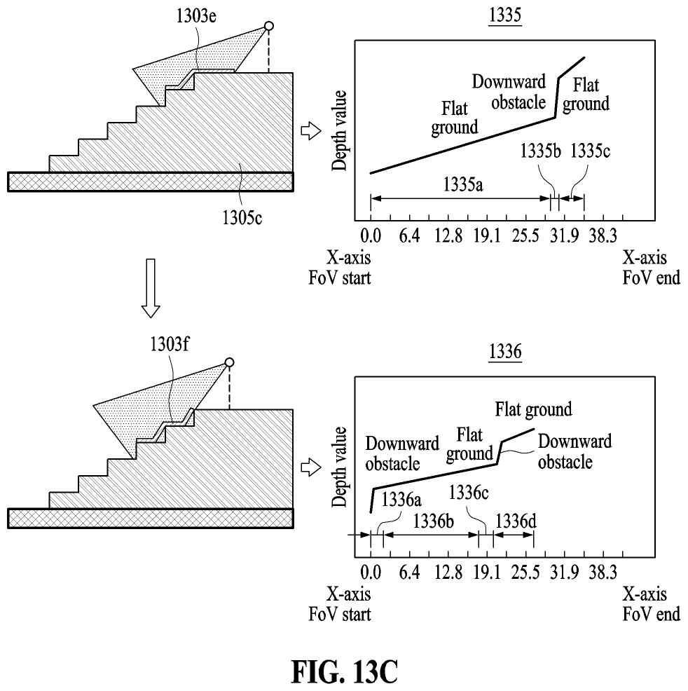

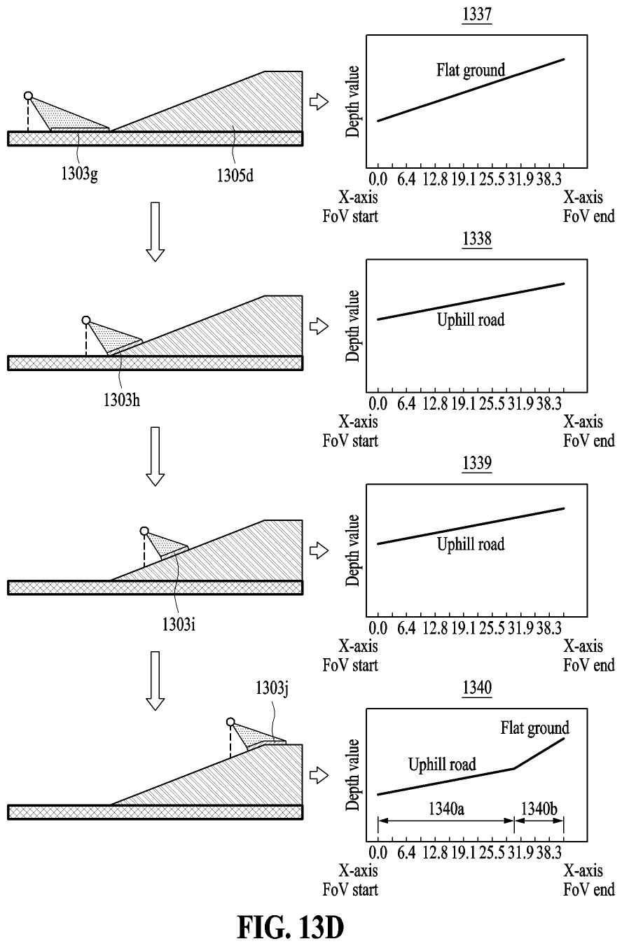

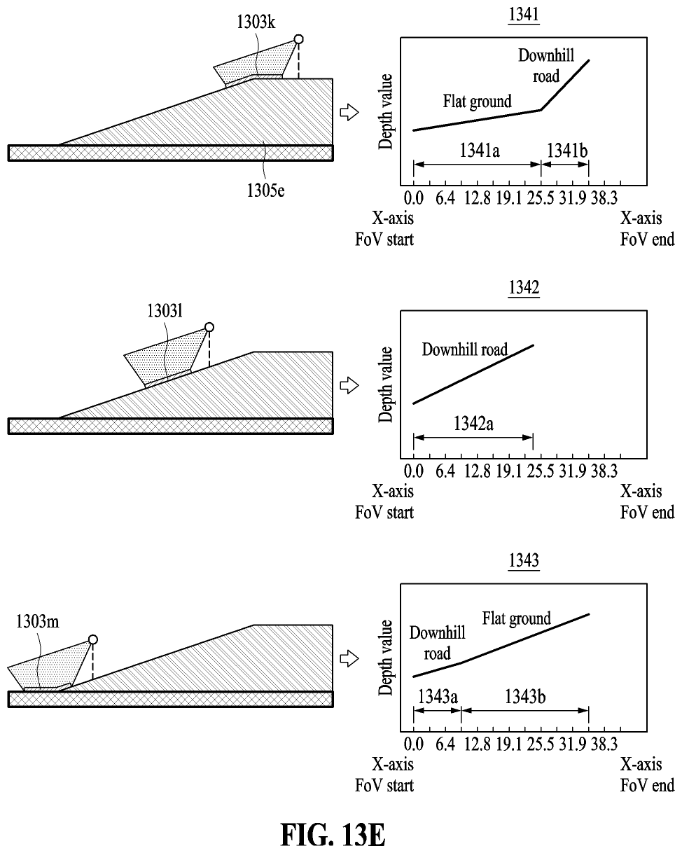

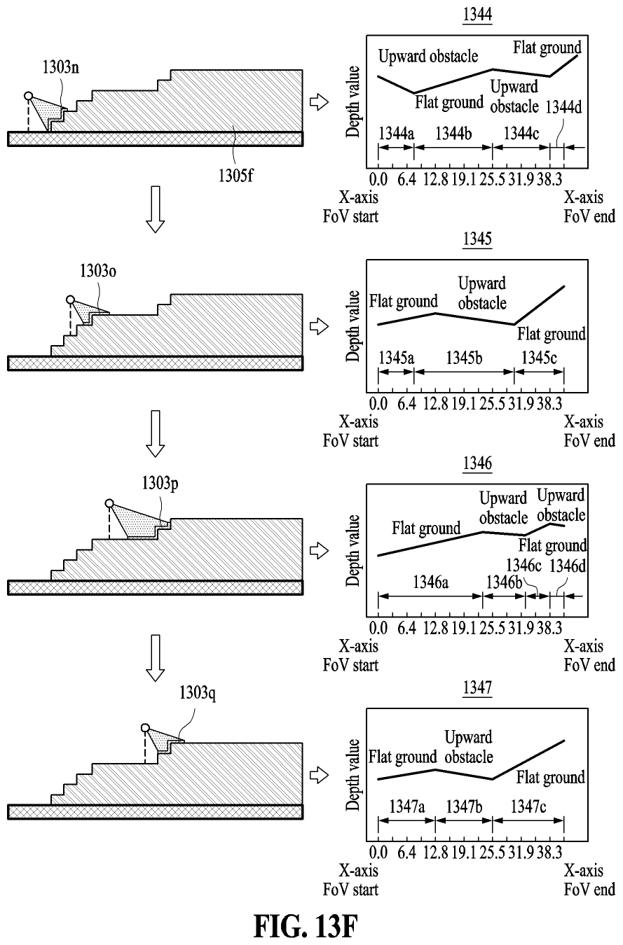

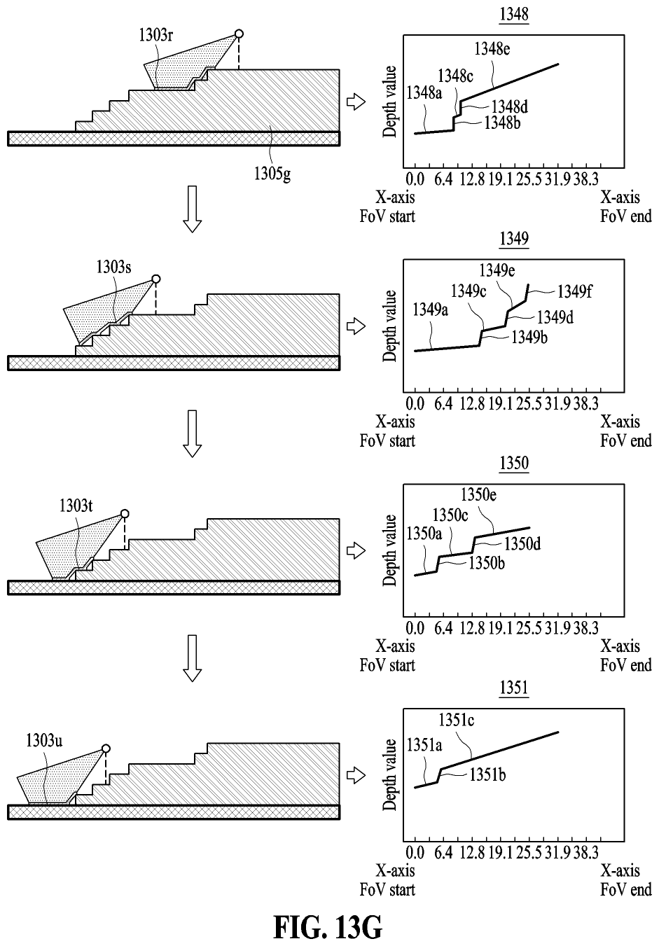

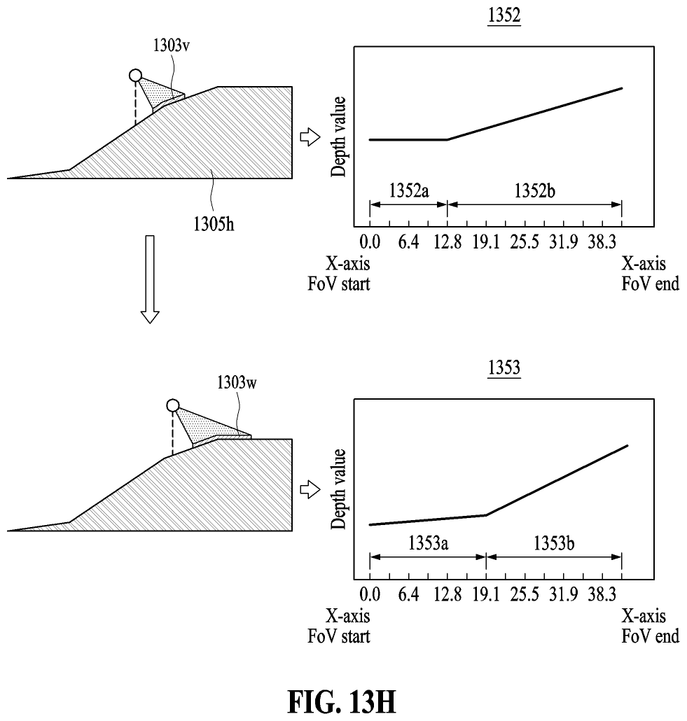

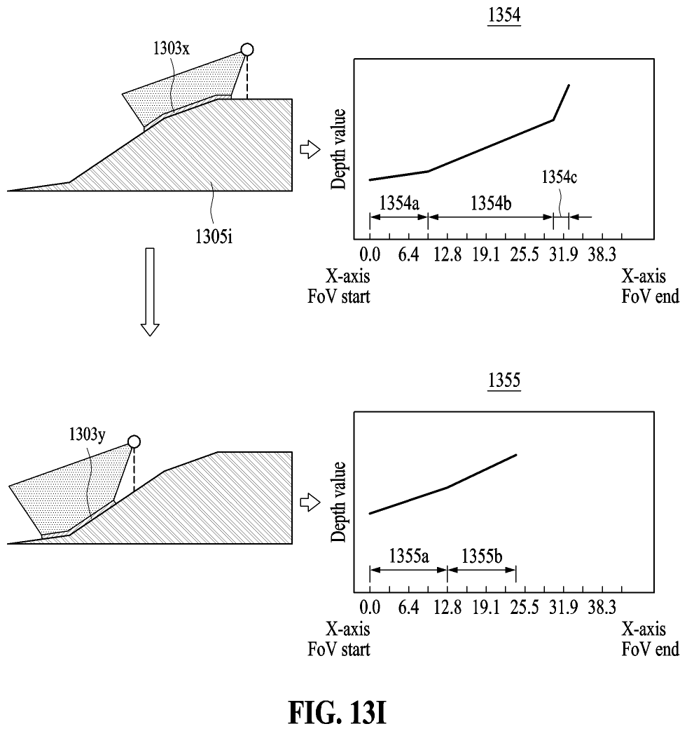

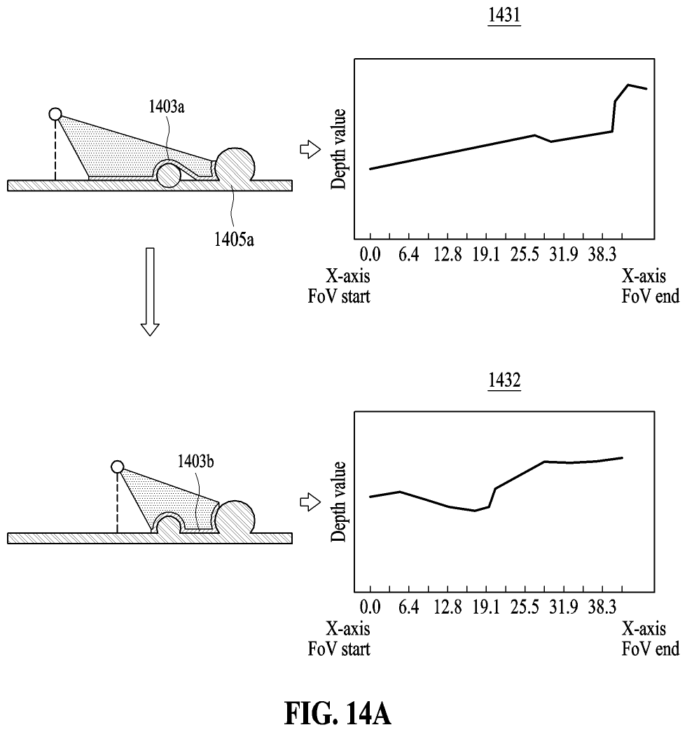

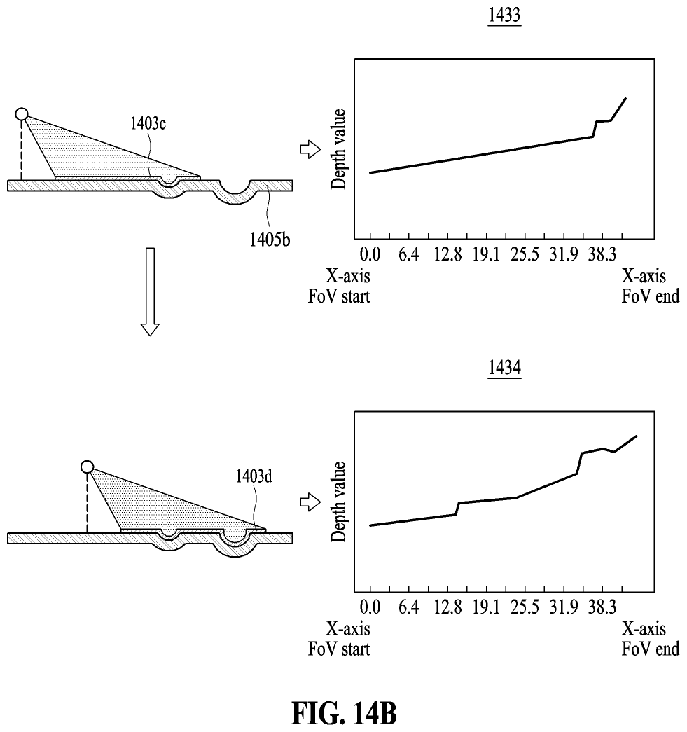

According to an embodiment, the first depth value pattern may be generated such that coordinate values in the first image of pixels positioned on the central axis of the first RoI and depth values of the pixels appear. For example, the first depth value pattern may be based on a coordinate system based on a first axis that places the pixels on the first RoI based on a distance from the user and a second axis that represents depth values of the pixels on the first axis. In the coordinate system, the first axis may be the horizontal axis and the second axis may be the vertical axis. The pixels on the first RoI may be disposed on the first axis so that the closer the pixels are to the user, the closer the pixels are to the origin of the coordinate system. The depth values corresponding to the pixels on the first axis may be disposed on the second axis. The first depth value pattern is described in detail below with reference to FIGS. 13A to 13I and FIGS. 14A and 14B.

In operation 950, the wearable device may determine a first state of the walking terrain corresponding to the first RoI based on the first depth value pattern. For example, the first state may be one of flat ground, an uphill road, a downhill road, uphill stairs, downhill stairs, an upward obstacle, or a downward obstacle.

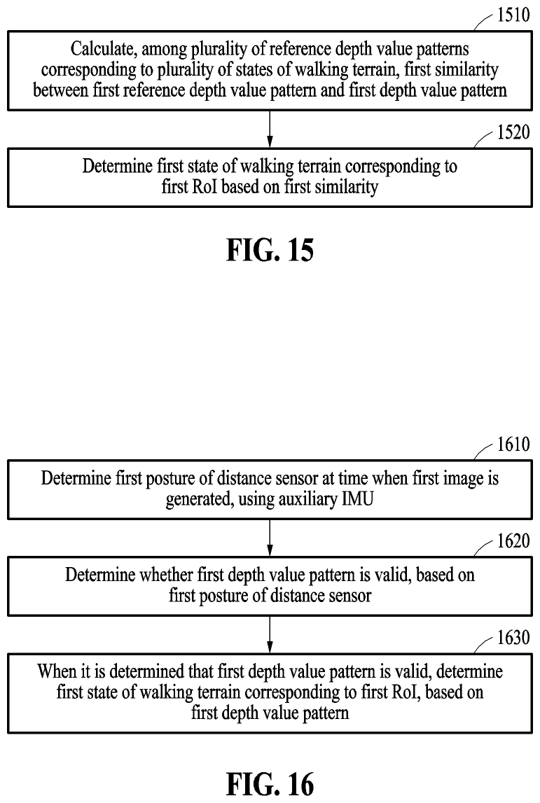

According to an embodiment, the wearable device may calculate a similarity between each of a plurality of reference depth value patterns corresponding to a plurality of states of the walking terrain and the first depth value pattern and may determine the first state of the walking terrain based on the calculated similarity. A method of determining the first state of the walking terrain based on the similarity between the depth value patterns is described in detail below with reference to FIG. 15.

Each embodiment herein may be used in combination with any other embodiment(s) described herein.

According to an embodiment, the wearable device may determine the first state of the walking terrain using a model, based on the first depth value pattern and a pre-trained artificial intelligence neural network. For example, the model may determine one of flat ground, an uphill road, a downhill road, uphill stairs, downhill stairs, an upward obstacle, or a downward obstacle to be the first state of the walking terrain. For example, the model may determine a degree of a slope for an uphill road or a downhill road to be the first state of the walking terrain.

According to an embodiment, operations 910 to 950 may be performed when exercise or walking of the user who is wearing the wearable device is detected. For example, when the user stops walking for a preset time, the performance of operations 910 to 950 may be stopped. When the user resumes walking again, operation 910 may be performed again. When operation 910 is performed again, the first RoI that is previously set in the first image, the first depth value pattern for the first RoI, and the first state of the walking terrain corresponding to the first RoI may be initialized. “Based on” as used herein covers based at least on.

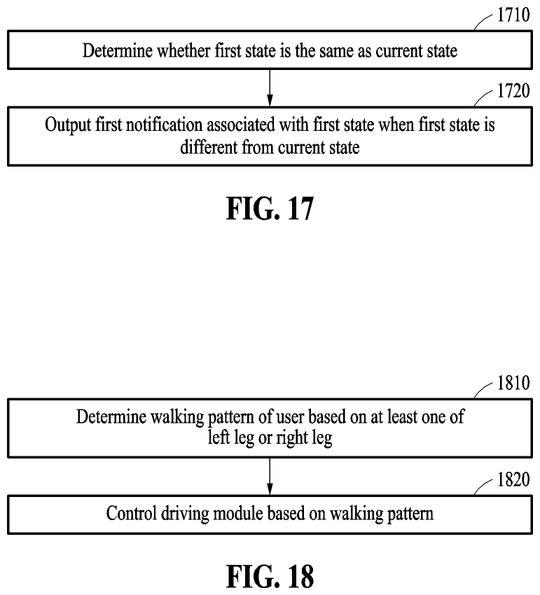

According to an embodiment, the wearable device may be controlled based on the determined first state of the walking terrain. For example, the wearable device may output a notification for the first state to alert the user. A method of outputting the notification is described in detail below with reference to FIG. 17.

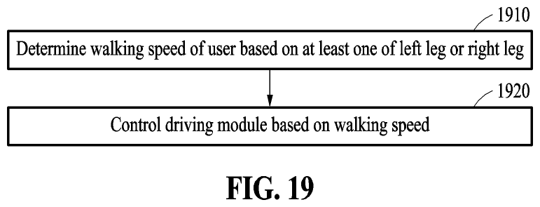

According to an embodiment, the wearable device may determine a walking pattern or walking speed of the user based on the left leg or the right leg identified based on the first image and may be controlled based on the determined walking pattern or walking speed. A method of controlling the wearable device based on the walking pattern of the user is described in detail below with reference to FIG. 18. A method of controlling the wearable device based on the walking speed of the user is described in detail below with reference to FIG. 19.

FIG. 10 is a flowchart illustrating a method of setting an RoI based on at least one of the left leg or the right leg of a user in an identified image, according to an embodiment.

According to an embodiment, operations 1010 and 1020 below may be related to operation 930 described above with reference to FIG. 9. For example, operation 930 may include operations 1010 and 1020. Operations 1010 and 1020 may be performed by a control module (e.g., the control module 130 of FIG. 1 or the control module 510 of FIG. 5A, comprising processing circuitry) including at least one processor (e.g., the at least one processor 512 of FIG. 5) configured to control a wearable device and a memory (e.g., the memory 514 of FIG. 5) configured to store instructions executable by the at least one processor.

In operation 1010, the wearable device may determine a central axis in a first image based on a position of the left leg and a position of the right leg identified based on the first image. For example, the wearable device may determine the position of the left leg and the position of the right leg of a user in a scene based on the first image and previous images of the first image.

According to an embodiment, the wearable device may determine an expected path for the left leg based on the position of the left leg identified based on the previous image generated before the first image. For example, the expected path for the left leg may be set to be parallel to the walking direction of the user, starting from the identified position of the left leg. For example, the expected path for the left leg may be set as a straight line connecting a first position to a second position of the identified left leg. The first position of the left leg may be the most recently identified position of the left leg, and the second position of the left leg may be the position of the left leg identified before the first position.

According to an embodiment, the wearable device may set the expected path for the left leg in the first image.

According to an embodiment, the wearable device may generate a point cloud for a scene based on the first image and may set the expected path for the left leg in the generated point cloud.

According to an embodiment, the wearable device may determine an expected path for the right leg based on the position of the right leg identified based on the first image. For example, the expected path for the right leg may be set to be parallel to the walking direction of the user, starting from the identified position of the right leg. For example, the expected path for the right leg may be set as a straight line connecting a first position to a second position of the identified right leg. The first position of the right leg may be the position of the right leg identified based on the first image, and the second position of the right leg may be the position of the right leg identified before the first position.

According to an embodiment, the wearable device may set the expected path for the right leg in the first image.

According to an embodiment, the wearable device may generate a point cloud for a scene based on the first image and may set the expected path for the right leg in the generated point cloud.

According to an embodiment, the wearable device may determine the central axis based on the expected path for the left leg and the expected path for the right leg. For example, the wearable device may determine the central axis to be positioned in the middle of the expected path for the left leg and the expected path for the right leg. The wearable device may set the determined central axis in the first image. The central axis may be an expected path for the torso of the user.

In operation 1020, the wearable device may set a first RoI in the first image based on the central axis. For example, the first RoI may be the central axis. For example, the first RoI may be a region with a preset size including the central axis.

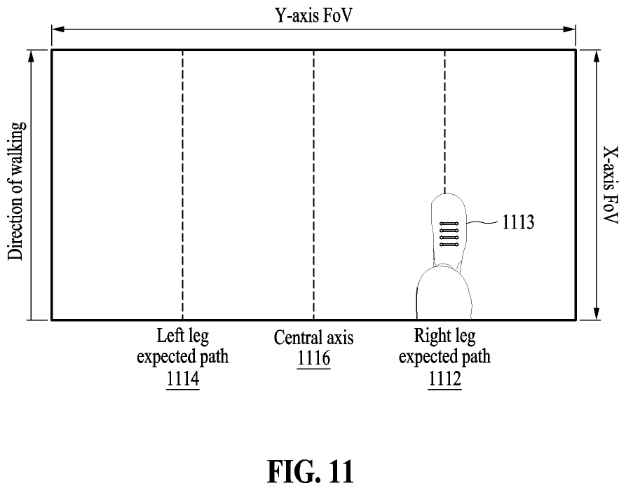

FIG. 11 illustrates a method of identifying the left leg or the right leg of a user in an image and setting an RoI based on the identified leg, according to an embodiment.

According to an embodiment, a wearable device (e.g., the wearable device 100 of FIG. 1) may identify a position 1113 of the right leg in a first image 1110. The wearable device may set a right leg expected path 1112 based on the position 1113 of the right leg. For example, the right leg expected path 1112 may be parallel to the direction of walking.

According to an embodiment, a left leg expected path may be set based on a previous image of the first image 1110. The wearable device may set a left leg expected path 1114 in the first image 1110 based on the left leg expected path set in the previous image.

According to an embodiment, the wearable device may set a central axis 1116 in the first image 1110 based on the right leg expected path 1112 and the left leg expected path 1114.

FIG. 12 illustrates a method of setting an RoI based on a first image, according to an embodiment.

According to an embodiment, a wearable device (e.g., the wearable device 100 of FIG. 1) may generate a first image 1220, which is a depth map, by capturing a scene 1210 using a distance sensor module (e.g., the first distance sensor module 810 or the second distance sensor module 820 of FIG. 8). The scene 1210 may be uphill stairs. The first image 1220 may be a portion of the original first image. The legs of the user may appear in the original first image.

According to an embodiment, the wearable device may generate a first image 1230, which is a point cloud, by capturing the scene 1210 using the distance sensor module. The first image 1230 may be a portion of the entire point cloud. The legs of the user may appear in the entire point cloud.

According to an embodiment, the wearable device may set the central axis in the first image 1220 or the first image 1230 and may determine an RoI 1240 based on the set central axis. The RoI 1240 may correspond to uphill stairs in the direction in which the user walks.

FIG. 13A illustrates a depth value pattern generated when a state of a terrain is flat ground, according to an embodiment.

According to an embodiment, a user may be walking on flat ground with uphill stairs 1305a ahead. A distance sensor module (e.g., the first distance sensor module 810 or the second distance sensor module 820 of FIG. 8) may generate a first image by capturing a scene of flat ground 1303a at point 1301. The first image generated by the distance sensor module may have a Z-axis in the depth direction, a Y-axis in the horizontal direction, and an X-axis that is orthogonal to each of the X-axis and the Y-axis. The width of the first image may correspond to the Y-axis FoV of a distance sensor, and the height may correspond to the X-axis FoV of the distance sensor. Each pixel of the first image may include distance information about a point in a corresponding scene.

A wearable device may set a first RoI in the first image and may generate a first depth value pattern 1331 for the first RoI. For example, the first depth value pattern 1331 may be based on a coordinate system defined by a first axis that places pixels on the first RoI based on a distance from the user and a second axis that represents depth values of the pixels on the first axis.

The pixels of the first RoI set for the flat ground 1303a may have relatively large depth values as the pixels move away from the user. Accordingly, the first depth value pattern 1331 for the flat ground 1303a may have a gradually increasing graph.

The uphill stairs 1305a may appear after the flat ground 1303a, but since the X-axis FoV of the distance sensor does not correspond to the uphill stairs 1305a, a depth value for the uphill stairs 1305a may not appear in the first depth value pattern 1331.

FIG. 13B illustrates depth value patterns generated when a state of a terrain is uphill stairs, according to an embodiment.

According to an embodiment, a user may be walking uphill stairs. A distance sensor module (e.g., the first distance sensor module 810 or the second distance sensor module 820 of FIG. 8) may generate a first image by capturing a first scene 1303b of uphill stairs 1305b while the user is walking. A wearable device may set a first RoI in the first image and may generate a first depth value pattern 1332 for the first RoI. A first section 1332a of the first depth value pattern 1332 may correspond to flat ground, and a second section 1332b may correspond to an upward obstacle. A first state of a walking terrain may be determined to be an upward obstacle based on the first depth value pattern 1332.

The distance sensor module may generate a first image by capturing a first scene 1303c of the uphill stairs 1305b while the user is walking. The wearable device may set a first RoI in the first image and may generate a first depth value pattern 1333 for the first RoI. A first section 1333a of the first depth value pattern 1333 may correspond to flat ground, a second section 1333b may correspond to an upward obstacle, and a third section 1333c may correspond to flat ground. The first state of the walking terrain may be determined to be uphill stairs based on the first depth value pattern 1333.

The distance sensor module may generate a first image by capturing a first scene 1303d of the uphill stairs 1305b while the user is walking. The wearable device may set a first RoI in the first image and may generate a first depth value pattern 1334 for the first RoI. A first section 1334a of the first depth value pattern 1334 may correspond to an upward obstacle, a second section 1334b may correspond to flat ground, a third section 1334c may correspond to an upward obstacle. The first state of the walking terrain may be determined to be uphill stairs based on the first depth value pattern 1334.

FIG. 13C illustrates depth value patterns generated when a state of a terrain is downhill stairs, according to an embodiment.

According to an embodiment, a user may be walking downhill stairs. A distance sensor module (e.g., the first distance sensor module 810 or the second distance sensor module 820 of FIG. 8) may generate a first image by capturing a first scene 1303e of downhill stairs 1305c while the user is walking. A wearable device may set a first RoI in the first image and may generate a first depth value pattern 1335 for the first RoI. A first section 1335a of the first depth value pattern 1335 may correspond to flat ground, a second section 1335b may correspond to a downward obstacle, and a third section 1335c may correspond to flat ground. A first state of a walking terrain may be determined to be a downward obstacle based on the first depth value pattern 1335.

The distance sensor module may generate a first image by capturing a first scene 1303f of the downhill stairs 1305c while the user is walking. The wearable device may set a first RoI in the first image and may generate a first depth value pattern 1336 for the first RoI. A first section 1336a of the first depth value pattern 1336 may correspond to a downward obstacle, a second section 1336b may correspond to flat ground, a third section 1336c may correspond to a downward obstacle, and a fourth section 1336d may correspond to flat ground. The first state of the walking terrain may be determined to be downhill stairs based on the first depth value pattern 1336.

FIG. 13D illustrates depth value patterns generated when a state of a terrain is an uphill road, according to an embodiment.

According to an embodiment, a user may be walking on flat ground with an uphill road 1305d ahead. A distance sensor module (e.g., the first distance sensor module 810 or the second distance sensor module 820 of FIG. 8) may generate a first image by capturing a first scene 1303g while the user is walking. A wearable device may set a first RoI in the first image and may generate a first depth value pattern 1337 for the first RoI. The first depth value pattern 1337 may correspond to flat ground.

The distance sensor module may generate a first image by capturing a first scene 1303h of the uphill road 1305d while the user is walking. The wearable device may set a first RoI in the first image and may generate a first depth value pattern 1338 for the first RoI. The first depth value pattern 1338 may correspond to an uphill road. A first state of a walking terrain may be determined to be an uphill road based on the first depth value pattern 1338. As the first state of the walking terrain, a degree of slope of an uphill road may be additionally determined.

The distance sensor module may generate a first image by capturing a first scene 1303i of the uphill road 1305d while the user is walking. The wearable device may set a first RoI in the first image and may generate a first depth value pattern 1339 for the first RoI. The first depth value pattern 1339 may correspond to an uphill road. The first state of the walking terrain may be determined to be an uphill road based on the first depth value pattern 1339. As the first state of the walking terrain, a degree of slope of an uphill road may be additionally determined.

The distance sensor module may generate a first image by capturing a first scene 1303j of the uphill road 1305d while the user is walking. The wearable device may set a first RoI in the first image and may generate a first depth value pattern 1340 for the first RoI. A first section 1340a of the first depth value pattern 1340 may correspond to an uphill road, and a second section 1340b may correspond to flat ground. The first state of the walking terrain may be determined to be an uphill road with flat ground ahead, based on the first depth value pattern 1340.

FIG. 13E illustrates depth value patterns generated when a state of a terrain is a downhill road, according to an embodiment.

According to an embodiment, a user may be walking on flat ground with a downhill road 1305e ahead. A distance sensor module (e.g., the first distance sensor module 810 or the second distance sensor module 820 of FIG. 8) may generate a first image by capturing a first scene 1303k while the user is walking. A wearable device may set a first RoI in the first image and may generate a first depth value pattern 1341 for the first RoI. A first section 1341a of the first depth value pattern 1341 may correspond to flat ground, and a second section 1341b may correspond to a downhill road. A first state of a walking terrain may be determined to be a flat ground with a downhill road ahead, based on the first depth value pattern 1341.

The distance sensor module may generate a first image by capturing a first scene 13031 of the downhill road 1305e while the user is walking. The wearable device may set a first RoI in the first image and may generate a first depth value pattern 1342 for the first RoI. A first section 1342a of the first depth value pattern 1342 may correspond to a downhill road. The first state of the walking terrain may be determined to be a downhill road based on the first depth value pattern 1342. As the first state of the walking terrain, a degree of slope of a downhill road may be additionally determined.

The distance sensor module may generate a first image by capturing a first scene 1303m of the downhill road 1305e while the user is walking. The wearable device may set a first RoI in the first image and may generate a first depth value pattern 1343 for the first RoI. A first section 1343a of the first depth value pattern 1343 may correspond to a downhill road, and a second section 1343b may correspond to flat ground. The first state of the walking terrain may be determined to be a downhill road with flat ground ahead, based on the first depth value pattern 1343.

FIG. 13F illustrates depth value patterns generated when a state of a terrain includes uphill stairs and flat ground, according to an embodiment.

According to an embodiment, a user may be walking uphill stairs 1305f. A distance sensor module (e.g., the first distance sensor module 810 or the second distance sensor module 820 of FIG. 8) may generate a first image by capturing a first scene 1303n of the uphill stairs 1305f while the user is walking. A wearable device may set a first RoI in the first image and may generate a first depth value pattern 1344 for the first RoI. A first section 1344a of the first depth value pattern 1344 may correspond to an upward obstacle, a second section 1344b may correspond to flat ground, a third section 1344c may correspond to an upward obstacle, and a fourth section 1344d may correspond to flat ground. A first state of a walking terrain may be determined to be uphill stairs based on the first depth value pattern 1344.

The distance sensor module may generate a first image by capturing a first scene 13030 of the uphill stairs 1305f while the user is walking. The wearable device may set a first RoI in the first image and may generate a first depth value pattern 1345 for the first RoI. A first section 1345a of the first depth value pattern 1345 may correspond to flat ground, a second section 1345b may correspond to an upward obstacle, and a third section 1345c may correspond to flat ground. The first state of the walking terrain may be determined to be uphill stairs based on the first depth value pattern 1345.

The distance sensor module may generate a first image by capturing a first scene 1303p of the uphill stairs 1305f while the user is walking. The wearable device may set a first RoI in the first image and may generate a first depth value pattern 1346 for the first RoI. A first section 1346a of the first depth value pattern 1346 may correspond to flat ground, a second section 1346b may correspond to an upward obstacle, a third section 1346c may correspond to flat ground, and a fourth section 1346d may correspond to an upward obstacle. The first state of the walking terrain may be determined to be uphill stairs based on the first depth value pattern 1346.

The distance sensor module may generate a first image by capturing a first scene 1303q of the uphill stairs 1305f while the user is walking. The wearable device may set a first RoI in the first image and may generate a first depth value pattern 1347 for the first RoI. A first section 1347a of the first depth value pattern 1347 may correspond to flat ground, a second section 1347b may correspond to an upward obstacle, and a third section 1347c may correspond to flat ground. The first state of the walking terrain may be determined to be uphill stairs based on the first depth value pattern 1347.

FIG. 13G illustrates depth value patterns generated when a state of a terrain includes a downhill slope and flat ground, according to an embodiment.

According to an embodiment, a user may be walking downhill stairs 1305g. A distance sensor module (e.g., the first distance sensor module 810 or the second distance sensor module 820 of FIG. 8) may generate a first image by capturing a first scene 1303r of the downhill stairs 1305g while the user is walking. A wearable device may set a first RoI in the first image and may generate a first depth value pattern 1348 for the first RoI. A first section 1348a of the first depth value pattern 1348 may correspond to flat ground, a second section 1348b may correspond to a downward obstacle, a third section 1348c may correspond to flat ground, a fourth section 1348d may correspond to a downward obstacle, and a fifth section 1348e may correspond to flat ground. A first state of a walking terrain may be determined to be downhill stairs based on the first depth value pattern 1348.

The distance sensor module may generate a first image by capturing a first scene 1303s of the downhill stairs 1305g while the user is walking. The wearable device may set a first RoI in the first image and may generate a first depth value pattern 1349 for the first RoI. A first section 1349a of the first depth value pattern 1349 may correspond to flat ground, a second section 1349b may correspond to a downward obstacle, a third section 1349c may correspond to flat ground, a fourth section 1349d may correspond to a downward obstacle, a fifth section 1349e may correspond to flat ground, and a sixth section 1349f may correspond to a downward obstacle. The first state of the walking terrain may be determined to be downhill stairs based on the first depth value pattern 1349.

The distance sensor module may generate a first image by capturing a first scene 1303t of the downhill stairs 1305g while the user is walking. The wearable device may set a first RoI in the first image and may generate a first depth value pattern 1350 for the first RoI. A first section 1350a of the first depth value pattern 1350 may correspond to flat ground, a second section 1350b may correspond to a downward obstacle, a third section 1350c may correspond to flat ground, a fourth section 1350d may correspond to a downward obstacle, and a fifth section 1350e may correspond to flat ground. The first state of the walking terrain may be determined to be downhill stairs based on the first depth value pattern 1350.

The distance sensor module may generate a first image by capturing a first scene 1303u of the downhill stairs 1305g while the user is walking. The wearable device may set a first RoI in the first image and may generate a first depth value pattern 1351 for the first RoI. A first section 1351a of the first depth value pattern 1351 may correspond to flat ground, a second section 1351b may correspond to a downward obstacle, and a third section 1351c may correspond to flat ground. The first state of the walking terrain may be determined to be downhill stairs with a flat ground ahead, based on the first depth value pattern 1351.

FIG. 13H illustrates depth value patterns generated when a state of a terrain is an uphill road with a changing degree of slope, according to an embodiment.

According to an embodiment, a user may be walking on an uphill road 1305h. A distance sensor module (e.g., the first distance sensor module 810 or the second distance sensor module 820 of FIG. 8) may generate a first image by capturing a first scene 1303v while the user is walking. A wearable device may set a first RoI in the first image and may generate a first depth value pattern 1352 for the first RoI. A first section 1352a of the first depth value pattern 1352 may correspond to an uphill road having a first degree of slope, and a second section 1352b may correspond to an uphill road having a second degree of slope. A first state of a walking terrain may be determined to be an uphill road with a changing degree of slope, based on the first depth value pattern 1352.

The distance sensor module may generate a first image by capturing a first scene 1303w of the uphill road 1305h while the user is walking. The wearable device may set a first RoI in the first image and may generate a first depth value pattern 1353 for the first RoI. A first section 1353a of the first depth value pattern 1353 may correspond to an uphill road having a second degree of slope, and a second section 1353b may correspond to flat ground. The first state of the walking terrain may be determined to be an uphill road with flat ground ahead, based on the first depth value pattern 1353.

FIG. 13I illustrates depth value patterns generated when a state of a terrain is a downhill road with a changing degree of slope, according to an embodiment.

According to an embodiment, a user may be walking on a downhill road 1305i. A distance sensor module (e.g., the first distance sensor module 810 or the second distance sensor module 820 of FIG. 8) may generate a first image by capturing a first scene 1303x while the user is walking. A wearable device may set a first RoI in the first image and may generate a first depth value pattern 1354 for the first RoI. A first section 1354a of the first depth value pattern 1354 may correspond to a downhill road having a first degree of slope, a second section 1354b may correspond to a downhill road having a second degree of slope, and a third section 1354c may correspond to a downhill road having a third degree of slope. A first state of a walking terrain may be determined to be a downhill road with a changing degree of slope, based on the first depth value pattern 1354.

The distance sensor module may generate a first image by capturing a first scene 1303y of the downhill road 1305i while the user is walking. The wearable device may set a first RoI in the first image and may generate a first depth value pattern 1355 for the first RoI. A first section 1355a of the first depth value pattern 1355 may correspond to a downhill road having a second degree of slope, and a second section 1355b may correspond to a downhill road having a third degree of slope. The first state of the walking terrain may be determined to be a downhill road with a changing degree of slope, based on the first depth value pattern 1355.

FIG. 14A illustrates depth value patterns generated for a state of a terrain where upward obstacles are on flat ground, according to an embodiment.

According to an embodiment, a user may be walking on flat ground 1405a where upward obstacles are positioned. A distance sensor module (e.g., the first distance sensor module 810 or the second distance sensor module 820 of FIG. 8) may generate a first image by capturing a first scene 1403a while the user is walking. A wearable device may set a first RoI in the first image and may generate a first depth value pattern 1431 for the first RoI. A first state of a walking terrain may be determined to be flat ground where upward obstacles are positioned, based on the first depth value pattern 1431.

The distance sensor module may generate a first image by capturing a first scene 1403b while the user is walking. The wearable device may set a first RoI in the first image and may generate a first depth value pattern 1432 for the first RoI. The first state of the walking terrain may be determined to be flat ground where upward obstacles are positioned, based on the first depth value pattern 1432.

FIG. 14B illustrates depth value patterns generated for a state of a terrain where downward obstacles are on flat, according to an embodiment.

According to an embodiment, a user may be walking on flat ground 1405b where downward obstacles are positioned. A distance sensor module (e.g., the first distance sensor module 810 or the second distance sensor module 820 of FIG. 8) may generate a first image by capturing a first scene 1403c while the user is walking. A wearable device may set a first RoI in the first image and may generate a first depth value pattern 1433 for the first RoI. A first state of a walking terrain may be determined to be flat ground where downward obstacles are positioned, based on the first depth value pattern 1433.

The distance sensor module may generate a first image by capturing a first scene 1403d while the user is walking. The wearable device may set a first RoI in the first image and may generate a first depth value pattern 1434 for the first RoI. The first state of the walking terrain may be determined to be flat ground where downward obstacles are positioned, based on the first depth value pattern 1434.

FIG. 15 is a flowchart illustrating a method of determining a first state of a walking terrain corresponding to a first RoI based on a first reference depth value pattern, according to an embodiment.

According to an embodiment, operations 1510 and 1520 below may be related to operation 950 described above with reference to FIG. 9. For example, operation 950 may include operations 1510 and 1520. Operations 1510 and 1520 may be performed by a control module (e.g., the control module 130 of FIG. 1 or the control module 510 of FIG. 5A) including at least one processor (e.g., the at least one processor 512 of FIG. 5) configured to control a wearable device and a memory configured to store instructions executable by the at least one processor.

In operation 1510, the wearable device may calculate, among a plurality of reference depth value patterns corresponding to a plurality of states of a walking terrain, a first similarity between a first reference depth value pattern and a first depth value pattern. For example, the wearable device may calculate similarities between each of the plurality of reference depth value patterns and the first depth value pattern. Each of the plurality of reference depth value patterns may be a depth value pattern standardized for a state of a corresponding walking terrain. The plurality of reference depth value patterns may be generated in advance and stored in the wearable device.

In operation 1520, the wearable device may determine a first state of the walking terrain corresponding to a first RoI based on the calculated first similarity. For example, the wearable device may determine, among the similarities calculated between each of the plurality of reference depth value patterns and the first depth value pattern, a state of the walking terrain corresponding to a similarity having the greatest value to be the first state.

FIG. 16 is a flowchart illustrating a method of determining a first state of a walking terrain corresponding to a first RoI based on a second reference depth value pattern generated based on a first posture of a distance sensor, according to an embodiment.

According to an embodiment, operations 1610 to 1630 below may be related to operation 950 described above with reference to FIG. 9. For example, operation 950 may include operations 1610 to 1630. Operations 1610 to 1630 may be performed by a control module (e.g., the control module 130 of FIG. 1 or the control module 510 of FIG. 5A) including at least one processor (e.g., the at least one processor 512 of FIG. 5) configured to control a wearable device and a memory (e.g., the memory 514 of FIG. 5) configured to store instructions executable by the least one processor.

In operation 1610, the wearable device may determine a first posture of a distance sensor (e.g., the distance sensor 814 of FIG. 8B) at a time when a first image is generated, using an auxiliary IMU (e.g., the auxiliary IMU 812 of FIG. 8B). For example, a posture of the auxiliary IMU may be determined to be the first posture of the distance sensor.

In operation 1620, the wearable device may determine whether a first depth value pattern is valid, based on the first posture of the distance sensor. For example, when a tilt angle of the distance sensor with respect to the horizontal plane is a°, it may be determined whether a is within a preset effective tilt angle range.

In operation 1630, when it is determined that the first depth value pattern is valid, the wearable device may determine the first state of the walking terrain corresponding to the first RoI, based on the first depth value pattern.

FIG. 17 is a flowchart illustrating a method of outputting a first notification associated with a first state, according to an embodiment.

According to an embodiment, operations 1710 and 1720 below may be performed after operation 950 described above with reference to FIG. 9 is performed. Operations 1710 and 1720 may be performed by a control module (e.g., the control module 130 of FIG. 1 or the control module 510 of FIG. 5A) including at least one processor (e.g., the at least one processor 512 of FIG. 5) configured to control a wearable device and a memory (e.g., the memory 514 of FIG. 5) configured to store instructions executable by the at least one processor.

In operation 1710, the wearable device may determine whether a first state of a walking terrain is the same as a current state. For example, the current state may be a state of the walking terrain determined before the first state is determined.

For example, when the current state of the walking terrain is an uphill road having a first degree of slope, and the first state is an uphill road having a second degree of slope, the current state and the first state may be determined to be the same or different depending on a preset slope condition for the state determination.

In operation 1720, the wearable device may output a first notification associated with the first state when the first state of the walking terrain is different from the current state. The first notification may be a message to alert a user.

According to an embodiment, the wearable device may output vibration associated with the first notification so that the user may feel tactile feedback. For example, the wearable device may output vibration using a separate vibration motor. For example, the wearable device may output a notification torque as vibration using a motor (e.g., the motor 534 of FIG. 5A) configured to generate a torque.

According to an embodiment, the wearable device may output sound associated with the first notification so that the user may receive auditory feedback.

According to an embodiment, the wearable device may output a screen associated with the first notification through a display or may output light through a lighting unit (e.g., the lighting unit 85 of FIG. 3) so that the user may receive visual feedback.

FIG. 18 is a flowchart illustrating a method of controlling a driving module based on a walking pattern of a user, according to an embodiment.

According to an embodiment, operations 1810 and 1820 below may be performed after operation 920 described above with reference to FIG. 9 is performed. Operations 1810 and 1820 may be performed by a control module (e.g., the control module 130 of FIG. 1 or the control module 510 of FIG. 5A) including at least one processor (e.g., the at least one processor 512 of FIG. 5) configured to control a wearable device and a memory (e.g., the memory 514 of FIG. 5) configured to store instructions executable by the at least one processor.

In operation 1810, the wearable device may determine a walking pattern of a user based on at least one of the left leg or the right leg identified based on a first image. The wearable device may determine the walking pattern of the user based on a posture of the identified left leg. For example, the posture of the left leg may be an angle between an expected path and the left sole or shoe placed on an expected path of the left. For example, the walking pattern of the user may be limp on the left leg. For example, the walking pattern of the user may be a straight step. For example, the walking pattern of the user may be an in-toeing step. For example, the walking pattern of the user may be an out-toeing step.

In operation 1820, the wearable device may control a driving module based on the determined walking pattern of the user. For example, when the walking pattern of the user is limp on the left leg, the wearable device may control the drive module so that an auxiliary torque for the left leg is output to be stronger than an auxiliary torque for the right leg. For example, when the walking pattern of the user is an in-toeing step, the wearable device may control the drive module so that a torque capable of correcting the in-toeing step is output. For example, when the walking pattern of the user is an out-toeing step, the wearable device may control the drive module so that a torque capable of correcting the out-toeing step is output.

According to an embodiment, the wearable device may calculate a first torque to assist the walking of the user, calculate a second torque that is calculated based on the walking pattern of the user, calculate a third torque based on the first torque and the second torque, and control the driving module so that the third torque is output. For example, the first torque may be determined based on a current state of a walking cycle of the user and a walking terrain. A current state of the walking terrain may be a state of a walking terrain on which the legs of the user are standing.

FIG. 19 is a flowchart illustrating a method of controlling a driving module based on a walking speed of a user, according to an embodiment.

According to an embodiment, operations 1910 and 1920 below may be performed after operation 920 described above with reference to FIG. 9 is performed. Operations 1910 and 1920 may be performed by a control module (e.g., the control module 130 of FIG. 1 or the control module 510 of FIG. 5A) including at least one processor (e.g., the at least one processor 512 of FIG. 5) configured to control a wearable device and a memory (e.g., the memory 514 of FIG. 5) configured to store instructions executable by the at least one processor.

In operation 1910, the wearable device may determine the walking speed of the user based on at least one of the left leg or the right leg identified based on a first image. For example, the walking speed of the user may be determined based on a position of the left leg identified based on the first image and a position of the left leg identified based on a previous image of the first image. For example, the walking speed may be determined based on a time between the creation time of the previous image and the creation time of the first image and a distance to which the left leg is moved.

In operation 1920, the wearable device may control the driving module based on the walking speed. For example, the wearable device may calculate a torque based on a walking cycle of the user and the walking speed and may control the driving module so that the calculated torque is output.

The method of determining the first state of the walking terrain based on the first image generated using a distance sensor module (e.g., the first distance sensor module 810 or the second distance sensor module 820 of FIG. 8) is described above with reference to FIGS. 9 to 19.

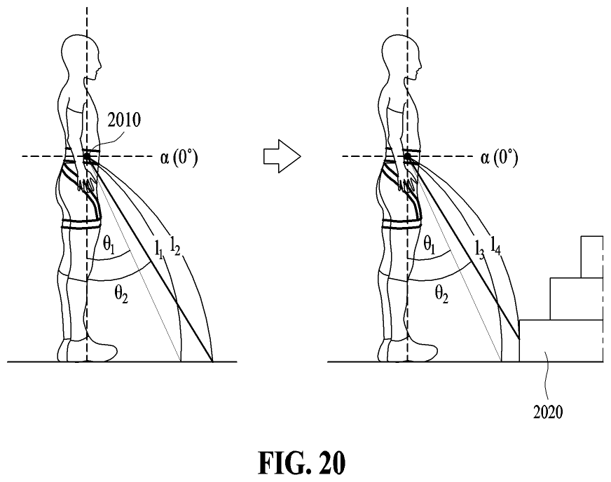

A method of determining a first state of a walking terrain based on a plurality of depths for different points in a scene that is calculated using a distance sensor module (e.g., the first distance sensor module 810 or the second distance sensor module 820 of FIG. 8) is described with reference to FIGS. 20 to 23.

FIG. 20 illustrates a method of determining a state of a walking terrain using a plurality of distance sensors, according to an embodiment.

According to an embodiment, a wearable device (e.g., the wearable device 100 of FIG. 1) may include a distance sensor module 2010 (e.g., the first distance sensor module 810 or the second distance sensor module 820 of FIG. 8). The distance sensor module 2010 may include a first distance sensor and a second distance sensor. The first distance sensor and the second distance sensor may be disposed side by side in the distance sensor module 2010. Each of the first distance sensor and the second distance sensor may calculate a distance to a point in a corresponding scene. The distance sensor module 2010 may further include an auxiliary IMU (e.g., the auxiliary IMU 812 of FIG. 8). The auxiliary IMU may determine a posture of the auxiliary IMU.

For example, the first distance sensor may be installed on the wearable device such that the central axis of the first distance sensor has an angle of θ₁° with respect to the direction of gravity while a user is wearing the wearable device. For example, when a tilt angle measured by the auxiliary IMU is θ°, the angle formed between the central axis of the first distance sensor and the direction of gravity may be θ₁°.

For example, the second distance sensor may be installed on the wearable device such that the central axis of the second distance sensor has an angle of θ₂° with respect to the direction of gravity while the user is wearing the wearable device. For example, when a tilt angle measured by the auxiliary IMU is θ°, the angle formed between the central axis of the second distance sensor and the direction of gravity may be θ₂°. The distance or depth to a first point in the scene calculated by the second distance sensor may be 1₂.

According to an embodiment, when the user is on flat ground, the distance or depth to the first point in the scene calculated by the first distance sensor may be 1₁ and the distance or depth to a second point in the scene calculated by the second distance sensor may be 1₂.

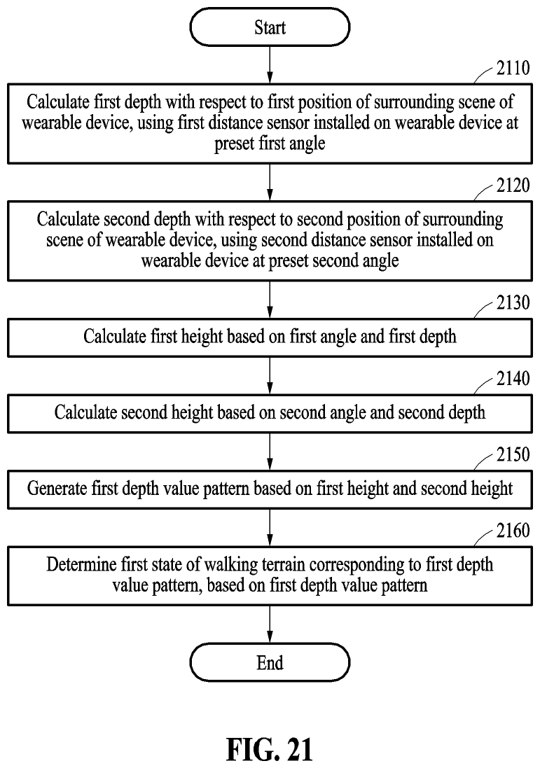

According to an embodiment, when the user is in front of uphill stairs 2020, the distance or depth to a third point in the scene calculated by the first distance sensor may be 1₃ and the distance or depth to a fourth point in the scene calculated by the second distance sensor may be 1₄. 1₃ may be the same as 1₁. 1₄ may be less than 1₂ by the uphill stairs 2020. The wearable device may determine a first state of a walking terrain based on a first depth calculated by the first distance sensor and a second depth calculated by the second distance sensor. A method of determining the first state of the walking terrain based on the first depth and the second depth is described in detail below with reference to FIG. 21.

FIG. 21 is a flowchart illustrating a method of determining a state of a walking terrain using a plurality of distance sensors, according to an embodiment.

Operations 2110 to 2160 below may be performed by a wearable device (e.g., the wearable device 100 of FIG. 1). For example, operations 2110 to 2160 may be performed by a control module (e.g., the control module 130 of FIG. 1 or the control module 510 of FIG. 5A) including at least one processor (e.g., the at least one processor 512 of FIG. 5) configured to control the wearable device and a memory (e.g., the memory 514 of FIG. 5) configured to store instructions executable by the least one processor.

In operation 2110, the wearable device may calculate a first depth (e.g., 1₁ or 1₃ of FIG. 20) with respect to a first position (or a first point) of a surrounding scene of the wearable device, using a first distance sensor installed on the wearable device at a preset first angle.

In operation 2120, the wearable device may calculate a second depth (e.g., 1₂ or 1₄ of FIG. 20) with respect to a second position (or a second point) of a surrounding scene of the wearable device, using a second distance sensor installed on the wearable device at a preset second angle.

In operation 2130, the wearable device may calculate a first height based on the preset first angle and the first depth. When both a current walking terrain of a user and a walking terrain ahead are flat grounds, the calculated first height may be the same as the height of the first distance sensor from the ground. For example, the first height may be calculated using Equation 1 below.

$$First Height = {l}_{1} \times cos {θ}_{1} \qquad [ Equation 1 ]$$

In operation 2140, the wearable device may calculate a second height based on the preset second angle and the second depth. For example, the second height may be calculated using Equation 2 below.

$$Second height = {l}_{2} \times cos {θ}_{2} \qquad [ Equation 2 ]$$

In operation 2150, the wearable device may generate a first depth value pattern based on the first height and the second height.

For example, the wearable device may calculate a first difference between the first height and the second height. As in an embodiment described above with reference to the left drawing of FIG. 20, when a state of a terrain corresponding to a first position is the same as a state of a terrain corresponding to a second position (e.g., when a terrain is flat ground), the first difference may be 0 or a value that is close to 0.

For example, the wearable device may calculate a second difference between a third height and a fourth height. As in an embodiment described above with reference to the right drawing of FIG. 20, when a state of a terrain corresponding to a third position is different from a state of a terrain corresponding to a fourth position (e.g., when a terrain is uphill stairs), as a fourth depth decreases compared to the second depth, a fourth height may increase compared to the second height. The calculated second difference between a third depth and the fourth depth may be negative.

According to an embodiment, the wearable device may generate the first depth value pattern by accumulating differences that are consecutively calculated according to the walking of the user. For example, the wearable device may generate the first depth value pattern to include a preset number of differences. When a new difference is calculated, the wearable device may exclude, among the differences of the first depth value pattern, a difference that is calculated first from the first depth value pattern and may add the new difference to the first depth value pattern.

The description of the first depth value pattern may be similarly applied to the description of FIGS. 13A to 13G and FIGS. 14A and 14B.

In operation 2160, the wearable device may determine the first state of the walking terrain corresponding to the first depth value pattern, based on the first depth value pattern. The description of the method of determining the first state of the walking terrain based on the first depth value pattern may be replaced with the description of operation 950 described above with reference to FIG. 9.

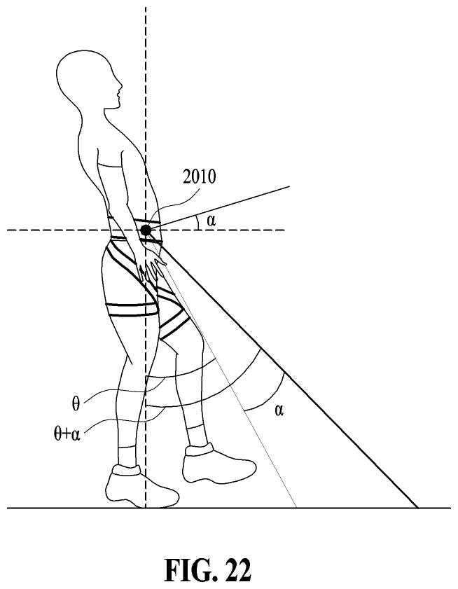

FIG. 22 illustrates a method of determining postures of a plurality of distance sensors, according to an embodiment.

According to an embodiment, a posture of the distance sensor module 2010 (e.g., the first distance sensor module 810 or the second distance sensor module 820 of FIG. 8) may be changed according to the motion of a user. As the posture of the distance sensor module 2010 changes, an angle formed between the central axis of a first distance sensor and the direction of gravity and an angle formed between the central axis of a second distance sensor and the direction of gravity may be changed.

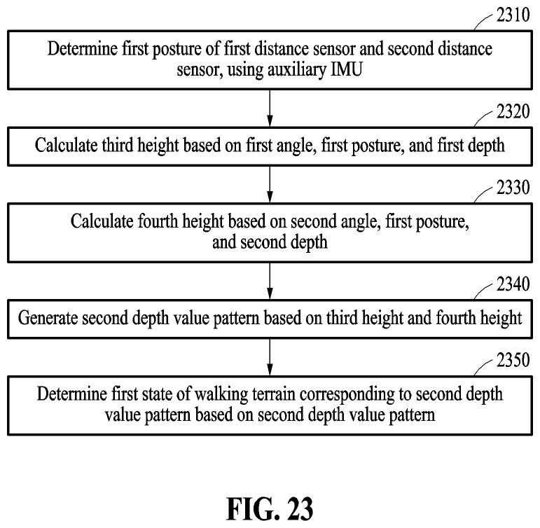

An auxiliary IMU (e.g., the auxiliary IMU 812 of FIG. 8) of the distance sensor module 2010 may determine the changed posture of the distance sensor module 2010. For example, a tilt angle of the determined posture of the distance sensor module 2010 may be a. When the posture of the distance sensor module 2010 is changed, a first height and a second height calculated based on the posture of the distance sensor module 2010 may be changed, so a generated first depth value pattern may be inaccurate. A method of generating the first depth value pattern based on the posture of the distance sensor module 2010 is described in detail below with reference to FIG. 23.

FIG. 23 is a flowchart illustrating a method of determining a state of a walking terrain based on postures of a plurality of distance sensors, according to an embodiment.

Operations 2310 to 2350 below may be performed by a wearable device (e.g., the wearable device 100 of FIG. 1). For example, operations 2310 to 2350 may be performed by a control module (e.g., the control module 130 of FIG. 1 or the control module 510 of FIG. 5A) including at least one processor (e.g., the at least one processor 512 of FIG. 5) configured to control the wearable device and a memory (e.g., the memory 514 of FIG. 5) configured to store instructions executable by the least one processor.

According to an embodiment, operation 2310 may be performed after operation 2110 described above with reference to FIG. 21 is performed.

In operation 2310, the wearable device may determine a first posture of a first distance sensor and a second distance sensor, using an auxiliary IMU (e.g., the auxiliary IMU 812 of FIG. 8) of a distance sensor module (e.g., the first distance sensor module 810, the second distance sensor module 820 of FIG. 8, or the distance sensor module 2010 of FIG. 20). For example, a tilt angle of the first distance sensor and the second distance sensor may be determined to be the first posture.

In operation 2320, the wearable device may calculate a third height based on a first angle, the first posture, and a first depth. For example, the third height may be calculated using Equation 3 below.

$$Third height = {l}_{1} \times cos ( {θ}_{1} + α ) \qquad [ Equation 3 ]$$

In operation 2330, the wearable device may calculate a fourth height based on a second angle, the first posture, and a second depth. For example, the fourth height may be calculated using Equation 4 below.

$$Fourth height = {l}_{2} \times cos ( {θ}_{2} + α ) \qquad [ Equation 4 ]$$

In operation 2340, the wearable device may generate a second depth value pattern based on the third height and the fourth height. The description of the method of generating the second depth value pattern may be similarly applied to the description of the method of generating the first depth value pattern.

In operation 2350, the wearable device may determine a first state of a walking terrain corresponding to the second depth value pattern based on the second depth value pattern. The description of the method of determining the first state of the walking terrain based on the second depth value pattern may be replaced with the description of operation 950 described above with reference to FIG. 9.

According to an embodiment, the wearable device 100 may include, when the wearable device 100 is worn on the body of the user 110, the base body 80 positioned at a waist area of the user 110, the waist support frame 20 and the second and first leg support frames 50 and 55 configured to support at least part of the body of the user 110, the second and first thigh fastening portions 1 and 2 configured to fix the second and first leg support frames 50 and 55 to the thigh of the user 110, the IMU 135 disposed within the base body 80, the second and first driving modules 35 and 45 and the driving module 120 configured to generate a torque to be applied to the leg of the user 110, in which the second and first driving modules 35 and 45 and the driving module 120 may be positioned between the waist support frame 20 and the second and first leg support frames 50 and 55, the angle sensor 125 configured to measure a rotation angle of the second and first leg support frames 50 and 55, the distance sensor 814 configured to calculate a distance to a surrounding scene of the wearable device 100, and the control modules 130 and 510 including the at least one processor 512 configured to control the wearable device 100 and the memory 514 configured to store instructions executable by the at least one processor 512, in which, when executed by the at least one processor 512, the instructions may cause the wearable device 100 to at least generate a first image by capturing a scene using the distance sensor 814, identify at least one of the left leg or the right leg of the user 110 in the first image based on depth information of the first image, set a first RoI in the first image based on at least one of the left leg or the right leg, generate a first depth value pattern for the first RoI based on depth information of the first RoI, and determine a first state of a walking terrain corresponding to the first RoI based on the first depth value pattern.

Each “processor” herein includes processing circuitry, and/or may include multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

According to an embodiment, each pixel of the first image may have an intensity value.

According to an embodiment, the each pixel of the first image may have a depth value.

According to an embodiment, when executed by the at least one processor 512, the instructions may cause the wearable device 100 to at least determine a central axis in the first image based on a position of the left leg and a position of the right leg and set the first RoI based on the central axis.

According to an embodiment, the first depth value pattern may be based on a coordinate system defined by a first axis that places pixels on the first RoI based on a distance from the user 110 and a second axis that represents depth values of the pixels on the first axis.

According to an embodiment, when executed by the at least one processor 512, the instructions may cause the wearable device 100 to at least calculate, among a plurality of reference depth value patterns corresponding to a plurality of states of a walking terrain, a first similarity between a first reference depth value pattern and the first depth value pattern, and determine the first state of the walking terrain corresponding to the first RoI based on the first similarity.

According to an embodiment, the first state of the walking terrain may be one of flat ground, an uphill road, a downhill road, uphill stairs, downhill stairs, an upward obstacle, or a downward obstacle.

According to an embodiment, the wearable device 100 may further include the auxiliary IMU 812 configured to measure a posture of the distance sensor 814, in which, when executed by the at least one processor 512, the instructions may cause the wearable device 100 to at least determine a first posture of the distance sensor 814 at a time when the first image is created, using the auxiliary IMU 812, determine whether the first depth value pattern is valid, based on the first posture, and determine the first state of the walking terrain corresponding to the first RoI based on the first depth value pattern when it is determined that the first depth value pattern is valid.

According to an embodiment, when executed by the at least one processor 512, the instructions may cause the wearable device 100 to at least determine whether the first state is the same as a current state and output a first notification associated with the first state when the first state is different from the current state.

According to an embodiment, when executed by the at least one processor 512, the instructions may cause the wearable device 100 to at least control the second and first driving modules 35 and 45 and the driving module 120 based on the first state.

According to an embodiment, when executed by the at least one processor 512, the instructions may cause the wearable device 100 to at least determine a walking pattern of the user 110 based on at least one of the left leg or the right leg and control the second and first driving modules 35 and 45 and the driving module 120 based on the walking pattern.

According to an embodiment, when executed by the at least one processor 512, the instructions may cause the wearable device 100 to at least determine a walking speed of the user 110 based on at least one of the left leg or the right leg and control the second and first driving modules 35 and 45 and the driving module 120 based on the walking speed.

According to an embodiment, a method, performed by the electronic device 100, of determining a state of a walking terrain may include generating a first image by capturing a scene using the distance sensor 814, identifying at least one of the left leg or the right leg of the user in the first image based on depth information of the first image, setting a first RoI in the first image based on at least one of the left leg or the right leg, generating a first depth value pattern for the first RoI based on depth information of the first RoI, and determining a first state of a walking terrain corresponding to the first RoI based on the first depth value pattern.

According to an embodiment, the wearable device 100 may include, when the wearable device 100 is worn on the body of the user 110, the base body 80 positioned at a waist area of the user 110, the waist support frame 20 and the second and first leg support frames 50 and 55 configured to support at least part of the body of the user 110, the second and first thigh fastening portions 1 and 2 configured to fix the second and first leg support frames 50 and 55 to the thigh of the user 110, the IMU 135 disposed within the base body 80, the second and first driving modules 35 and 45 and the driving module 120 configured to generate a torque to be applied to the leg of the user 110, in which the second and first driving modules 35 and 45 and the driving module 120 may be positioned between the waist support frame 20 and the second and first leg support frames 50 and 55, the angle sensor 125 configured to measure a rotation angle of the second and first leg support frames 50 and 55, a first distance sensor installed on the wearable device 100 at a preset first angle and configured to calculate a first depth for a first position of a surrounding scene of the wearable device 100, a second distance sensor installed on the wearable device 100 at a preset second angle and configured to calculate a second depth for a second position of the surrounding scene of the wearable device 100, and the control modules 130 and 510 including the at least one processor 512 configured to control the wearable device 100 and the memory 514 configured to store instructions executable by the at least one processor 512, in which, when executed by the at least one processor 512, the instructions may cause the wearable device 100 to at least calculate a first height based on the first angle and the first depth, calculate a second height based on the second angle and the second depth, generate a first depth value pattern based on the first height and the second height, and determine a first state of a walking terrain corresponding to the first depth value pattern based on the first depth value pattern.

According to an embodiment, the wearable device 100 may further include the auxiliary IMU 812 configured to measure a posture of the first distance sensor and the second distance sensor, in which, when executed by the at least one processor 512, the instructions may cause the wearable device 100 to at least determine a first posture of the first distance sensor and the second distance sensor using the auxiliary IMU 812, calculate a third height based on the first angle, the first posture, and the first depth, calculate a fourth height based on the second angle, the first posture, and the second depth, generate a second depth value pattern based on the third height and the fourth height, and determine the first state of the walking terrain corresponding to the second depth value pattern based on the second depth value pattern.

According to an embodiment, when executed by the at least one processor 512, the instructions may cause the wearable device 100 to at least calculate, among a plurality of reference depth value patterns corresponding to a plurality of states of a walking terrain, a first similarity between a first reference depth value pattern and the first depth value pattern and determine the first state of the walking terrain based on the first similarity.

According to an embodiment, when executed by the at least one processor 512, the instructions may cause the wearable device 100 to at least determine whether the first state is the same as a current state and output a first notification associated with the first state when the first state is different from the current state.

According to an embodiment, when executed by the at least one processor 512, the instructions may cause the wearable device 100 to at least control the second and first driving modules 35 and 45 and the driving module 120 based on the first state.

According to an embodiment, wherein the first state of the walking terrain may be one of flat ground, an uphill road, a downhill road, uphill stairs, downhill stairs, an upward obstacle, or a downward obstacle.

The embodiments described herein may be implemented using a hardware component, a software component and/or a combination thereof. A processing device may be implemented using one or more general-purpose or special-purpose computers, such as, for example, a processor, a controller and an arithmetic logic unit (ALU), a DSP, a microcomputer, a FPGA, a programmable logic unit (PLU), a microprocessor or any other device capable of responding to and executing instructions in a defined manner. The processing device may run an OS and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and/or multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD-ROM discs and/or DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher-level code that may be executed by the computer using an interpreter.

The above-described devices may be configured to act as one or more software modules in order to perform the operations of the above-described embodiments, or vice versa.

As described above, although the embodiments have been described with reference to the limited drawings, a person skilled in the art may apply various technical modifications and variations based thereon. For example, suitable results may be achieved if the described techniques are performed in a different order, and/or if components in a described system, architecture, device, or circuit are combined in a different manner, or replaced or supplemented by other components or their equivalents. While the disclosure has been illustrated and described with reference to various embodiments, it will be understood that the various embodiments are intended to be illustrative, not limiting. It will further be understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

Therefore, other implementations, other embodiments, and equivalents to the claims are also within the scope of the following claims.

What is claimed is:

1. A wearable device configured to be worn by a user, comprising:
a waist support frame and second and first leg support frames and configured to support at least part of a body of the user;
second and first thigh fastening portions configured to fix the second and first leg support frames to a thigh of the user;
wherein the wearable device is configured to be worn on a body of a user, and a base body thereof is configured to be positioned at a waist area of the user;
an inertial measurement unit (IMU), comprising a sensor, supported by the base body;
second and first driving modules, each comprising a motor and/or circuitry, each configured to generate torque to be applied to a respective leg of the user, wherein the second and first driving modules are positioned between the waist support frame and the second and first leg support frames;
an angle sensor configured to measure a rotation angle of the second and first leg support frames;
a distance sensor; and
at least one processor, comprising processing circuitry, individually and/or collectively configured to control the wearable device to:
generate a first image at least by capturing a scene using the distance sensor;
identify at least one of a left leg or a right leg of the user in the first image based on depth information of the first image;
set a first region of interest (RoI) in the first image based on at least one of the left leg or the right leg;
generate a first depth value pattern for the first RoI based on depth information of the first RoI; and
determine a first state of a walking terrain corresponding to the first RoI based on the first depth value pattern.

2. The wearable device of claim 1, wherein each pixel of the first image has an intensity value.

3. The wearable device of claim 1, wherein the each pixel of the first image has a depth value.

4. The wearable device of claim 1, wherein the at least one processor is individually and/or collectively configured to control the wearable device to:
determine a central axis in the first image based on a position of the left leg and a position of the right leg; and
set the first RoI based on the central axis.

5. The wearable device of claim 1, wherein the first depth value pattern is based on a coordinate system based on a first axis that places pixels on the first RoI based on a distance from the user and a second axis that represents depth values of the pixels on the first axis.

6. The wearable device of claim 1, wherein the at least one processor is individually and/or collectively configured to control the wearable device to:
calculate, among a plurality of reference depth value patterns corresponding to a plurality of states of a walking terrain, a first similarity between a first reference depth value pattern and the first depth value pattern; and
determine the first state of the walking terrain corresponding to the first RoI based on the first similarity.

7. The wearable device of claim 1, wherein the first state of the walking terrain is one of flat ground, an uphill road, a downhill road, uphill stairs, downhill stairs, an upward obstacle, or a downward obstacle.

8. The wearable device of claim 1, further comprising:
an auxiliary IMU, comprising a sensor, configured to measure a posture of the distance sensor,
wherein the at least one processor is individually and/or collectively configured to control the wearable device to:
determine a first posture of the distance sensor at a time when the first image is created, using the auxiliary IMU;
determine whether the first depth value pattern is valid, based on the first posture; and
determine the first state of the walking terrain corresponding to the first RoI based on the first depth value pattern when it is determined that the first depth value pattern is valid.

9. The wearable device of claim 1, wherein the at least one processor is individually and/or collectively configured to control the wearable device to:
determine whether the first state is the same as a current state; and
output a first notification associated with the first state when the first state is different from the current state.

10. The wearable device of claim 1, wherein the at least one processor is individually and/or collectively configured to control the wearable device to at least control the second and first driving modules based on the first state.

11. The wearable device of claim 1, wherein the at least one processor is individually and/or collectively configured to control the wearable device to:
determine a walking pattern of the user based on at least one of the left leg or the right leg; and
control the second and first driving modules based on the walking pattern.

12. The wearable device of claim 1, wherein the at least one processor is individually and/or collectively configured to control the wearable device to:
determine a walking speed of the user based on at least one of the left leg or the right leg; and
control the second and first driving modules based on the walking speed.

13. A method of determining a state of a walking terrain, the method performed by an electronic device and comprising:
generating a first image by capturing a scene using a distance sensor;
identifying at least one of a left leg or a right leg of a user in the first image based on depth information of the first image;
setting a first region of interest (RoI) in the first image based on at least one of the left leg or the right leg;
generating a first depth value pattern for the first RoI based on depth information of the first RoI; and
determining a first state of a walking terrain corresponding to the first RoI based on the first depth value pattern.

14. The method of claim 13, wherein the setting the first RoI in the first image based on at least one of the left leg or the right leg comprise:
determining a central axis in the first image based on a position of the left leg and a position of the right leg; and
setting the first RoI based on the central axis.

15. At least one non-transitory computer-readable storage medium individually and/or collectively storing instructions that, when executed by at least one processor, cause the at least one processor to individually and/or collectively perform the method of claim 13.

16. A wearable device comprising:
a waist support frame and second and first leg support frames configured to support at least part of a body of a user;
second and first thigh fastening portions configured to respectively fix the second and first leg support frames and to a thigh of the user;
when the wearable device is configured to be worn on a body of a user, with a base body thereof to be positioned at a waist area of the user;
an inertial measurement unit (IMU), comprising a sensor, disposed within the base body;
second and first driving modules, each comprising a motor and/or circuitry, and each configured to generate torque to be applied to a respective leg of the user, wherein the second and first driving modules are positioned between at least the waist support frame and the second and first leg support frames, respectively;
an angle sensor configured to measure a rotation angle of at least one of the second and first leg support frames;
a first distance sensor installed at a preset first angle and configured to calculate a first depth for a first position of a surrounding scene;
a second distance sensor installed at a preset second angle and configured to calculate a second depth for a second position of the surrounding scene; and
at least one processor, comprising processing circuitry, individually and/or collectively configured to:
calculate a first height based on the preset first angle and the first depth;
calculate a second height based on the preset second angle and the second depth;
generate a first depth value pattern based on the first height and the second height; and
determine a first state of a walking terrain corresponding to the first depth value pattern based on the first depth value pattern.

17. The wearable device of claim 16, further comprising:
an auxiliary IMU, comprising a sensor, configured to measure a posture of the first distance sensor and the second distance sensor,
wherein the at least one processor is individually and/or collectively configured to:
determine a first posture of the first distance sensor and the second distance sensor using the auxiliary IMU;
calculate a third height based on the preset first angle, the first posture, and the first depth;
calculate a fourth height based on the preset second angle, the first posture, and the second depth;
generate a second depth value pattern based on the third height and the fourth height; and
determine the first state of the walking terrain corresponding to the second depth value pattern based on the second depth value pattern.

18. The wearable device of claim 16, wherein the at least one processor is individually and/or collectively configured to:
calculate, among a plurality of reference depth value patterns corresponding to a plurality of states of a walking terrain, a first similarity between a first reference depth value pattern and the first depth value pattern; and
determine the first state of the walking terrain based on the first similarity.

19. The wearable device of claim 16, wherein the at least one processor is individually and/or collectively configured to:
determine whether the first state is the same as a current state; and
output a first notification associated with the first state when the first state is different from the current state.

20. The wearable device of claim 16, wherein the at least one processor is individually and/or collectively configured to control the second and first driving modules based on the first state.
